(19) United States
(12) Patent Application Publication
(10) Pub. No.: US 2007/0031746 A1
(43) Pub. Date: Feb. 8, 2007

(54) Electrophotographic photoconductor, process cartridge, and image forming method

(76) Inventors: Tetsuya Toshine, Numazu-shi (JP); Tetsuro Suzuki, Fuji-shi (JP); Hidetoshi Kami, Numazu-shi (JP); Yukio Fujiwara, Numazu-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/500,352

(22) Filed: Aug. 8, 2006

(30) Foreign Application Priority Data
Aug. 8, 2005 (JP) 2005-229020

(51) Int. Cl. G03G 5/047

(52) U.S. Cl. 430/58.7; 399/159; 430/58.05; 430/124

(57) ABSTRACT

The present invention provides an electrophotographic photoconductor which contains a substrate, at least a photosensitive layer and a surface layer being formed on the substrate in this order; the surface layer contains a cured material which is cured by irradiating with light a trifunctional or more radical polymerizable monomer having no electric charge transportable structure, a radical polymerizable monomer having an electric charge transportable structure, and a photo-radical polymerization initiator; the photo-radical polymerization initiator contains a titanocene derivative; and the relation between the absorption edge wavelength HA (nm) in the light absorption spectrum of the radical polymerization initiator and the absorption edge wavelength HB (nm) in the light absorption spectrum of the radical polymerizable monomer having an electric charge transportable structure is represented by HA>HB and satisfies HA−HB>40 nm.

### BACKGROUND OF THE INVENTION

1. Field of the Invention

The present invention relates to an electrophotographic photoconductor preferably used for copiers, laser printers, and plain paper facsimiles, and also relates to a process cartridge and an image forming method using the electrophotographic photoconductor.

2. Description of the Related Art

In recent years, for electrophotographic photoconductors (hereinafter may be referred to as “photoconductor” simply), organic photoconductors are widely used. Organic photoconductors are more advantageous than inorganic photoconductors in that materials compatible with various exposure light sources ranging from visible lights to infrared lights are easily developed, environmental pollution-free materials can be selected, and production cost is inexpensive. However, organic photoconductors are disadvantageous in that they are weak in physical strength, and chemical strength and easily cause abrasion and flaws (on a photoconductor) due to repetitive use over a long period of time.

Typically, an image forming apparatus based on electrophotographic technology is integrally provided with an electrophotographic photoconductor, a charge unit configured to charge the electrophotographic photoconductor, a latent image forming unit configured to form a latent electrostatic image on the surface of the electrophotographic photoconductor charged by the charge unit, a developing unit configured to make a toner adhere on image parts of the latent electrostatic image formed by the latent image forming unit, and a transferring unit configured to transfer the toner adhered on the image parts onto a transferring target. There may be an electrophotographic photoconductor which is further provided with a cleaning unit, in accordance with the necessity, which is configured to clean a residual toner being untransferred onto the transferring target and remaining on the surface of the photoconductor. Since a toner remaining on the photoconductor surface after transferring contributes to degradation of image quality, a large number of image forming apparatuses employ a cleaning unit.

For such a cleaning unit, typically, brushes, magnetic brushes, blades, and the like are used. In brush-cleaning, polyester fibers, acrylic fibers are used, and these fibers are optimized by changing the shape into a loop shape, a lissotrichic shape, etc, and the hardness and thickness of fibers before they are used. However, with brush cleaning, it is difficult to sufficiently remove a residual toner because fine powder particles slip through its fiber. In cleaning of residual toner using a magnetic brush, it gives a result similar to the above mentioned. In magnetic brush-cleaning, it has been tried that such a residual toner is electrostatically removed by applying voltage in electric fields, however, it is difficult to sufficiently clean a residual toner because an event where the toner scattered by an electrostatic force re-adheres on the photoconductor occurs. Thus, as cleaning units used nowadays, blade-cleaning using an elastic blade is predominately utilized from the perspective of removability of residual toner, cost performance, and making the residual toner into smaller diameters. In blade-cleaning, the surface layer of a photoconductor easily suffers from mechanical abrasion and flaws, because the photoconductor surface layer is slidably moved in a state where it makes contact with a cleaning blade, toner, and the like.

Since properties of the above-noted structural members of an image forming apparatus directly apply external physical forces to the surface of a photoconductor, it has been required to make a photoconductor to have durability to these structural members. In view of these problems, there have been reported a large number of study examples to enhance hardness of photoconductor surfaces. For example, Japanese Patent Application Laid Open (JP-A) Nos. 2001-125286, and 2001-324857 respectively propose to enhance the hardness of a photoconductor surface layer to prevent the photoconductor surface layer from being damaged when a magnetic brush is used as a charge unit, magnetic particles are involuntarily transferred onto the photoconductor, and then the particles are strongly pressed against the photoconductor surface in the transferring unit and/or the cleaning unit.

Japanese Patent Application Laid Open (JP-A) No. 2003-98708 proposes to enhance the hardness of the surface of a photoconductor to prevent abrasion of the photoconductor surface when a blade cleaning method is employed.

As a specific means to enhance the surface hardness of the above-mentioned photoconductors, a crosslinkable material such as a thermosetting resin, and a UV curable resin is used as a component of a photoconductor surface layer. For example, Japanese Patent Application Laid Open (JP-A) Nos. 05-181299, 2002-6526, and 2002-82465 respectively propose a method in which abrasion resistance and flaw resistance of a photoconductor surface layer are improved by using a thermosetting resin as a binder component of the surface layer. Further, Japanese Patent Application Laid Open (JP-A) Nos. 2000-284514, 2000-284515, and 2001-194813 respectively propose to improve abrasion resistance and flaw resistance of a photoconductor surface layer by using a siloxane resin having a crosslinking structure as an electric charge transporting material. Furthermore, in Japanese Patent Nos. 3194392 and 3286704, a method is reported in which a monomer having a carbon-carbon double bond, an electric charge transporting material having a carbon-carbon double bond, and a binder resin along with a binder and an electric charge transporting material to improve abrasion resistance and flaw resistance of a photoconductor surface layer.

In these crosslinkable materials, molecules are crosslinked to each other to thereby form a strong layer. As characteristics of these crosslinkable materials, these materials allow exhibiting different properties depending on the crosslinking conditions (for example, in the case of a thermosetting resin, temperature condition; in the case of a photo-curable resin, wavelength of light, illuminance, exposure dose, temperature condition, humidity condition, and the like) even when a same material is used.

In particular, photo-curable resins can be cured very fast and make it possible to obtain a layer having different properties even within a same planar surface by changing the conditions of light irradiation in some regions to be irradiated, and photo-curable resins have a wider range of versatility than that of thermosetting resins, and easily exhibit unique properties. For these reasons, photo-curable resins are utilized in industrial application such as pressure-sensitive tape in which tackiness thereof partially differs, and etching process etc. used for microscopic processing. However, to make desired properties exerted constantly, it is needed to set up manufacturing conditions in detail to manage them. When a photo-curable resin is used for a laminate structure, and the laminate structure is deteriorated by applying a light thereto, it is necessary to reduce influence upon the laminate structure as much as possible by selecting an emission wavelength of a light source to be used for curing, by selecting an initiator, and by selecting light irradiation conditions such as illuminance, and exposure dose.

In order to obtain desired properties such as hardness of a photoconductor by using a photo-crosslinkable material for the photoconductor surface layer, with a view to obtaining longer operating life of the photoconductor, it is not until processing conditions such as film-forming method, film-forming condition, and crosslinking condition are set to appropriate conditions using appropriate units that abrasion and flaws of photoconductor surface can be prevented and the photoconductor can be used for a long period of time.

Besides the mechanical durability, one of the most important properties required for an electrophotographic photoconductor is electric conductivity by means of exposure. Same applies to the case where a surface layer is formed on a photosensitive layer, like the present invention. For the reason, when a surface layer is formed on an electrophotographic photoconductor, it is necessary to add a component having electric charge transportability to the materials of the surface layer beforehand besides the photo-crosslinkable material. As an electric charge transportable material to be added for obtaining desired electric properties, basically, presence or absence of polymerizable functional group in the electric charge transportable material makes no difference. However, when an electric charge transportable material having no polymerizable functional group is added in a binder having a polymerizable functional group, the electric charge transportable material is not involved in the crosslinking, and therefore, it causes a reduction in the average crosslinking molecular mass in appearance, and consequently it is difficult to obtain sufficient mechanical durability. In view of these points, it is preferable to use an electric charge transportable material having a polymerizable functional group for a photo-crosslinkable surface layer to obtain desired mechanical durability and electric properties.

However, it has been known that triarylamine etc., well-known as a material having favorable electric charge transportability, has light-absorption property in wavelengths ranging from ultraviolet rays to visible short wavelengths. In the case of an acrylic acid ester or the like in which a conjugate bond is introduced into an electric charge transportable material to improve the electric charge transportability, it has a tendency that the absorption wavelength is shifted to the longer wavelength side.

When such an electric charge transportable material having light absorption property is used for a photoconductor surface layer, and the photoconductor surface layer is cured by light irradiation, special attention is required when selecting an initiator that will be a trigger of radical polymerization.

Photo-radical polymerization initiators have light absorption properties inherent in various materials and are excited by absorption of light in the light absorption wavelength range, and the exited state makes radical being a trigger of initiation of polymerization generated. For the reason, to cure a photo-crosslinkable material speedily and assuredly, it is needed to match the wavelength of light used for irradiating a curable film with the absorption property of a photo-polymerization initiator to make radical efficiently generated. When the thickness of the curable film is thick, it is important to select a light wavelength and an initiator in consideration of the absorption of the curable film itself, and particularly when a material having a large amount of light absorption is contained as a component of the curable film, it is necessary to select a light of irradiation and an initiator in consideration of the light absorption property thereof.

From these viewpoints, when an electric charge transportable material having the above-mentioned light absorption property is used for a photo-crosslinkable surface layer, and a generally used photo-polymerization initiator having light absorption at wavelengths close to 360 nm is used, the radical generation efficiency is degraded inside the film, and it is difficult to obtain desired film physical property, it invokes deterioration of the laminate structure (in this case, electric charge generating layer, and electric charge transporting layer) by applying the photo-crosslinkable surface layer with a light of an excessive exposure dose. Thus, it can hardly be said that it is appropriate.

For example, Japanese Patent Application Laid Open (JP-A) No. 2004-258344 achieves improvement in abrasion resistance while maintaining surface smoothness and electric property by using a pentafunctional or more acryl monomer and monofunctional acrylic donner to form a curable film, and the invention is worthy of attention, however, the absorption property of the electric charge transportable structure is exceedingly large, and when the curable film is thickened, a sufficient amount of exposure light cannot reach the inside of the layer, and the radical generation efficiency is degraded, curing of the inside of the layer tends to be insufficient, and it could not be said that they held sufficient abrasion resistance.

Similarly, JP-A No. 2004-258344 proposes a technique using a photo-polymerization initiator having a morphorino group and a dialkylamino group as a technique to improve abrasion resistance and flaw resistance of a photo-crosslinkable surface layer. These photo-polymerization initiators respectively exhibit high-speed curing rate and enables obtaining a smoothly cured film, however, tertiary amine structures substituted by dialkyl group remain in the surface layer, and thus these regions contribute to occurrences of electric charge trap, and repetitive use of the photoconductor result in an increase in residual potential.

### SUMMARY OF THE INVENTION

The object of the present invention is to provide a long-lived, high-performance electrophotographic photoconductor which has high-abrasion resistance and excels in surface smoothness in the case where a photo-crosslinkable material is used for improving abrasion resistance and flaw resistance of the surface layer of the electrophotographic photoconductor, and the electrophotographic photoconductor is stably usable for a long period of time because among electric properties thereof, in particular, it has a property that exposed regions are maintained at low-potential.

In view of the above-mentioned problems, the inventors of the present invention have investigated vigorously, and have obtained the following findings. Specifically, when an electrophotographic photoconductor is provided with a substrate, and at least a photosensitive layer and a surface layer being formed on the substrate in this order, and a photo-crosslinkable material is used to improve abrasion resistance and flaw resistance of the surface layer, it is possible to obtain an electrophotographic photoconductor which excels in abrasion resistance by making the surface layer contain at least a trifunctional or more radical polymerizable monomer having no electric charge transportable structure, a radical polymerizable monomer having an electric charge transportable structure, and a titanocene derivative, and by using the radical polymerizable monomer having an electric charge transportable structure having an absorption edge wavelength in the light absorption spectrum being 40 nm or more shorter than the absorption edge wavelength in the light absorption spectrum of the titanocene derivative to thereby make the surface layer cross-linked sufficiently through to the inside thereof with an appropriate exposure dose. According to the present invention, even when a crosslinking film contains an electric charge transportable material having light absorption of a relatively long wavelength, it is possible to obtain a cured film which is uniformly formed from the film surface through to the inside of the film as well as to obtain a desired mechanical durability with an appropriate exposure dose. As the result, it is possible to provide an electrophotographic photoconductor which will not cause defects relating to output image quality over a long period of time.

The electrophotographic photoconductor of the present invention is provided with a substrate, and at least a photosensitive layer and a surface layer being formed on the substrate in this order. The surface layer contains a cured material of which a trifunctional or more radical polymerizable monomer having no electric charge transportable structure, a radical polymerizable monomer having an electric charge transportable structure, and a photo-radical polymerization initiator contains a titanocene derivative, and the relation between the absorption edge wavelength HA (nm) in the light absorption spectrum of the radical polymerization initiator and the absorption edge wavelength HB (nm) in the light absorption spectrum of the radical polymerizable monomer having an electric charge transportable structure is represented by HA>HB and satisfies HA−HB>40 nm.

In the electrophotographic photoconductor of the present invention, it is possible to cure the surface layer of the electrophotographic photoconductor from the film surface through to the inside of the film with an appropriate exposure dose. As the result, it is possible to provide an electrophotographic photoconductor which excels in durability without substantially causing occurrences of abrasion and flaws that would result from repetitive use, and excels in electric properties deeply related to image quality.

The image forming method of the present invention includes at least forming a latent electrostatic image on an electrophotographic photoconductor, developing the latent electrostatic image using a toner to form a visible image, transferring the visible image onto a recording medium, and fixing the transferred image on the recording medium, in which the electrophotographic photoconductor is the electrophotographic photoconductor of the present invention.

The process cartridge of the present invention is provided with an electrophotographic photoconductor, and at least one selected from a charging unit configured to charge the surface of the electrophotographic photoconductor, a developing unit configured to develop a latent electrostatic image formed on the electrophotographic photoconductor using a toner to form a visible image, a transferring unit configured to transfer the visible image onto a recording medium, and a cleaning unit configured to remove the toner remaining on the electrophotographic photoconductor. The process cartridge can be detachably mounted to an image forming apparatus body, and the electrophotographic photoconductor is the electrophotographic photoconductor of the present invention.

Conventionally, in electrophotographic photoconductors, in order to prevent occurrences of abrasion and flaws that would result from repetitive use, it is effective to enhance the mechanical strength typified by hardness, and elastic power of the photoconductor surface. To enhance these properties, various methods and materials have been developed. To increase the mechanical strength, it is generally known that a crosslinkable material is used in which molecules are bonded to each other. Crosslinkable materials allow exhibiting various properties by selecting functional group structure, molecular structure, the number of functional groups, etc. and enable a molecular design allowing for not only a desired mechanical strength but also electric properties required for an electrophotographic photoconductor. For these reasons, crosslinkable materials have been a focus of attention.

Crosslinkable materials can be divided broadly into heat crosslinkable materials, photo-crosslinkable materials, and ionizable radiation-crosslinkable materials. Heat crosslinkable materials have a characteristic that inter-molecular crosslinking gradually proceed under room temperature or high-temperature conditions. Heat crosslinkable materials are widely used for industrial purposes because they are easily crosslinked by heat after being formed into a layer, requires only simple manufacturing facility, and has small impact on human body and environments. However, it takes a long time to cure heat crosslinkable materials, and they are readily influenced by manufacturing environments. Further, it takes a relative long time to cure them, and there is a need for application of heat while curing them, and thus there may be problems caused by inter-layer transition (migration) of low-molecular additives.

Photo-crosslinkable materials and ionizable radiation crosslinkable materials can be readily crosslinked by applying a give light or ionizing radiation thereto and allow instantaneously obtaining a highly crosslinked film (layer), and thus these materials have characteristics in that events such as environmental dependency and interlayer transition of low-molecular materials that could be observed in use of heat crosslinkable materials rarely occur. Photo-crosslinkable materials are widely used for industrial purposes because they require only simple system configuration of apparatuses for manufacturing and have a relatively small influence on human body. In contrast, most of manufacturing facilities required for ionizable radiation crosslinkable materials are complicated and expensive, and ionizable radiation crosslinkable material itself upon human body is undeniable, and thus at the present time, there are not many examples that ionizable radiation crosslinkable materials are used for industrial purposes.

Because of the above-mentioned reasons, it is conceivable that it is effective to use a photo-crosslinkable material for a surface layer of an electrophotographic photoconductor in order for the electrophotographic photoconductor to exhibit excellent mechanical strength. It should be here noted that to satisfy electric properties that can be the most important point for physical properties required for what an electrophotographic photoconductor should serve as an electrophotographic photoconductor, it is needed to add an electric charge transportable material to the composition of the surface layer thereof. Examples of materials having excellent electric charge transporting property generally include triarylamine materials, however, it is well known that those materials have one thing in common that they have light absorption property at a relatively long wavelength region. When a material having light absorption property is contained in a photo-crosslinkable material, like the present invention, there is apprehension that the cured condition would differ between the layer surface and the inside of the layer because it is impossible to make exposure light used in curing sufficiently reached through to the inside of the layer. For a light source used in curing of a photo-crosslinkable material, a light having a wavelength region of ultraviolet rays is commonly used, and therefore, when an electric charge transportable material having light absorption property at a relatively long wavelength region as described above, it requires extra caution in selecting materials and selecting curing conditions.

An electrophotographic photoconductor is positioned at the center of an image-forming process, and mechanical and/or electrical hazards are given thereto at the time of charging, toner-cleaning, and the like. For this reason, the surface of an electrophotographic photoconductor gradually wears with use, however, when the cured condition differs between the layer surface and the inside thereof, as mentioned above, it is conceivable that the electrophotographic photoconductor will not maintain a desired durability because the inside of the layer, which is different in the cured condition from that of the layer surface, will be exposed by abrasion wear.

Therefore, to maintain a desired durability of an electrographic photoconductor for a long period of time when using a photo-crosslinkable material for the surface layer thereof, it is important to minimize the difference in cured condition between the layer surface and the inside of the layer as much as possible. As a method for curing a surface layer uniformly when a material having light absorption property as described in the present invention is contained in the surface layer, for example, excessively applying a light to the surface layer at the time of crosslinking can be considered. However, for the one that is formed in a laminate structure like an electrophotographic photoconductor, influence of the excessive application of light upon other layers is feared. The electrophotographic photoconductor of the present invention takes a laminate structure that is commonly in wide use, however, electric charge generating materials and electric charge transporting materials tend to be easily deteriorated by application of light, and thus it is hard to say that this curing method is appropriate. Alternatively, setting the temperature condition at the time of crosslinking to relatively high-temperature can be considered, however, when such a method is used, it is difficult to obtain a stably crosslinked film (layer) due to material variations in lot-to-lot and influence of impurities in the material, resulting from the narrowed control margin, and in some cases, the surface layer is insufficiently crosslinked, desired surface physical properties may not be obtained. When the temperature condition is set to be high-temperature, it is feared that degradations in various properties in layers, which are caused by interlayer transition of low-molecular components such as additives. As the result, there is not only a possibility that potentials initially held by the materials cannot be sufficiently reflected to the product but also a possibility that specifications required as a product cannot be obtained.

The present invention is invented to solve these problems. The electrophotographic photoconductor of the present invention is characterized in that a photo-crosslinkable material is used in the surface layer, a photo-radical polymerization initiator used for the surface layer is a titanocene derivative, and as an electric charge transportable material used for the surface layer, the absorption edge wavelength of the light absorption spectrum of the electric charge transportable material is 40 nm shorter than the absorption edge wavelength in the light absorption spectrum of the titanocene derivative. With this configuration, it is possible to efficiently cure the surface layer and minimize the difference in cured condition between the layer surface and the inside of the layer. Consequently, the present inventors found that the electrophotographic photoconductor of the present invention excels in electric properties without substantially causing occurrences of abrasion and flaws that result from repetitive use and without substantially causing defects relating to output image quality of image forming apparatuses, and the experience and findings lead to the present invention.

### BRIEF DESCRIPTION OF THE DRAWINGS

FIG. 1 is a schematic view showing one example of an image forming apparatus to which the electrophotographic photoconductor of the present invention is applied.

FIG. 2 is a schematic view showing one example of the process cartridge of the present invention.

FIG. 3 is a graph showing properties of emission wavelength of a UV-ramp system used in Example 1.

FIG. 4 is a graph showing properties of emission wavelength of a ramp used in Examples 9 and 10.

### DESCRIPTION OF THE PREFERRED EMBODIMENTS

(Electrophotographic Photoconductor)

The electrophotographic photoconductor of the present invention has a substrate, and at least a photosensitive layer, and a surface layer being formed in this order on the substrate, and further has other layers in accordance with the necessity.

The photosensitive layer may take a unilaminar structure or a multi-layered structure as long as it has an electric charge generating function and an electric charge transporting function. When the photosensitive layer takes a multi-layered structure, it is commonly used a photosensitive layer in which an electric charge generating layer playing a role of electric charge generating function is provided separately from an electric charge transporting layer playing a role of electric charge transporting function (a function-separated laminate structure). When a photosensitive layer takes a function-separated laminate structure, the order of forming the electric charge generating layer and the electric charge transporting layer on the conductive substrate in a laminate structure is not particularly defined, however, when the electric charge generating layer is formed on the surface layer side, the electric charge generating layer is easily deteriorated by acid gas generated from a charger or the like, and it is difficult to apply the electric charge generating layer on the electric charge transporting layer without eroding the electric charge generating layer. For these reasons, in most case, the electric charge generating layer is formed on the conductive substrate side.

—Surface Layer—

In forming of the surface layer of the electrophotographic photoconductor described in the present invention, trifunctional or more radical polymerizable monomer is used. With this, a three-dimensional network is developed, and a highly cured surface layer which has an extremely high-crosslinking degree can be obtained, and high-abrasion resistance can be achieved. In contrast, just only a monofunctional or bifunctional radical polymerizable monomer is used, crosslinking bond in the crosslinked surface layer is insufficient, and drastic improvement in abrasion resistance is hardly achieved. When a large amount of high-molecular materials is contained in a non-crosslinkable surface layer, growth of a three-dimensional network is inhibited, the crosslinked network is sparse, and it is impossible to obtain more sufficient abrasion resistance than in the present invention. Further, the compatibility with the cured product generated by a reaction between high-molecular materials contained therein and a radical polymerizable composition (a radical polymerizable monomer having on electric charge transporting structure and a radical polymerizable monomer having an electric charge transporting structure) is poor, and phase-segregation of the materials easily cause degradation of the surface smoothness, local abrasion, and flaws on the electrophotographic photoconductor. The surface layer in the present invention further contains a radical polymerizable monomer having an electric charge transportable structure in addition to a trifunctional or more radical polymerizable monomer having no electric charge transportable structure, and the radical polymerizable monomer having an electric charge transportable structure is incorporated into a crosslinking bond at the time of curing the trifunctional or more radical polymerizable monomer. In contrast, when a low-molecular electric charge transporting material having no functional group is contained in a surface layer to be crosslinked, the low-molecular electric charge transporting material is precipitated, and gets whitey cloudy due to the low compatibility, and this result in a reduction of mechanical strength of the crosslinked surface layer.

In the present invention, when the trifunctional or more radical polymerizable monomer having no electric charge transportable structure and the radical polymerizable monomer having an electric charge transportable structure are cured with a light, a titanocene derivative is used as a polymerization initiator. By using the titanocene derivative, the surface layer can be sufficiently cured from the surface layer through to the inside of the layer, and excellent durability can be kept on the electrophotographic photoconductor over a long period of time. Further, an electrophotographic photoconductor capable of keeping potentials of exposed regions low over a long period of time can be provided. This can be explained below. When forming a crosslinkable surface layer described in the present invention, the surface layer contains a radical polymerizable monomer having an electric charge transporting structure as a component. Since the electric charge transportable sites usually have light absorption property at a relatively long wavelength region, the radical yield is reduced with a commonly used photo-radical polymerization initiator. Thus, it is necessary to irradiate the surface layer with light for long hours or with high-illuminance when the surface layer is cured, and the electric charge transportable structure in the surface layer or the photosensitive layer is dissolved, which may be a cause of degradations of properties. To increase the radical yield, a method of increasing the content of a photo-polymerization initiator is usable, however, this substantially reduce the contents of the radical polymerizable monomer and an electric charge transportable compound in the crosslinkable surface layer, and may cause degradation of abrasion resistance and an increase in residual potential, and the excessive amount of the photo-radical polymerization initiator may cause a termination reaction of radical polymerization. Thus, the method cannot be said as a beneficial method because it may cause degradation of abrasion resistance. In contrast, since most of titanocene derivatives have light absorption in visible regions of wavelengths of 400 nm or more, and they efficiently generate radical by irradiation of light having a wavelength region that cannot be absorbed to the radical polymerizable monomer having an electric charge transportable structure, an uniformly cured film can be obtained from the layer surface through to the inside of the layer. Thus, a crosslinked film (layer) which excels in smoothness can be obtained without causing convexes and concaves (irregularities) resulting from differences in hardness and volume shrinkage between cured portions and not-cured portions. The reason that the present invention does not cause degradation of electric properties such as increase in residual potential is that the surface layer does not include tertiary amino groups such as dialkylamino groups, and morphorino groups, which are used as a structure sensitizing radical generation of a photo-polymerization initiator, and the present invention does not cause deteriorations of electric charge transportable materials in the surface layer and the photosensitive layer resulting from exposure with an excessive dose of light and high-illuminance of light.

<Absorption Peak Wavelength>

The absorption edge wavelength of the electric charge transportable material and the photo-radical polymerization initiator defined in the present invention is a wavelength equivalent to transition energy of HOMO-LUMO specific to respective materials. Namely, in a typical region with a relatively large amount of light absorption close to the light absorption edge at the longwavelength side, it is conceivable that in the relation between an absorption coefficient α, a light energy hν (h is a Plank's constant, and ν is a wavenumber), and a band gap energy E₀, the following formula is established.
αhν=B(hν−E₀)²

In the above formula, B is a constant number.

Specifically, the absorption spectrum is measured; based on the absorption spectrum value, the value hν is plotted for the value obtained from (αhν) 0.5; the value of hν obtained by extrapolating the straight line therebetween, when α is equal to zero, is a transition energy E₀; and the value of wavelength equivalent to the transition energy obtained by the following equation will be the absorption edge wavelength.
λ₀=hc/E₀

In the above equation, c represents a light speed.

When calculating an absorption edge wavelength based on the calculation stated above, it is necessary to obtain a relation between absorbance relative to wavelength (absorption properties) as to respective materials. The measurement method of light absorption properties is not particularly limited, however, when a target material has little light absorption (for example, in the case where the content of the electric charge transportable material is excessively low relative to the bulk thereof, etc.) it is very difficult to calculate λ₀. For this reason, it is preferable to use a material of which the absorbance of the sites close to the light absorption edge at the longwavelength side is 1 or more and less than 3.

—Polymerization Initiator—

For the titanocene derivative, all known titanocene derivatives can be used. Examples thereof include titanocene derivatives described in Japanese Patent Application Laid Open (JP-A) Nos. 59-152396, 61-151197, 63-41484, 02-249, and 02-4705. Specific examples thereof include bis(cyclopentadienyl)-di-chloro-titanium, bis(cyclopentadienyl)-di-phenyl-titanium, bis(cyclopentadienyl)-bis(2,3,4,5,6 pentafluorophenyl)titanium, bis(cyclopentadienyl)-bis(2,6 difluorophenyl)titanium, bis(methylcyclopentadienyl)-bis(2,3,4,5,6 pentafluorophenyl) titanium, bis(methylcyclopentadienyl)-bis(2,6 difluorophenyl) titanium, bis(cyclopentadienyl)-bis[2,6-difluoro-3-(2-(1-pil-1-yl)ethyl) phenyl]titanium, bis(cyclopentadienyl)-bis[2,6-difluoro-3((1-pil-1-yl) methyl phenyl) titanium, bis(methylcyclopentadienyl)-bis[2,6-difluoro-3-((1-pil-1-yl)methyl) phenyl]titanium, bis(cyclopentadienyl)-bis[2,6-difluoro-3-((2,5-dimethyl-1-pil-1-yl) methyl)phenyl]titanium, bis(cyclopentadienyl)-bis[2,6-difluoro-3-((3-trimethylsilyl-2,5-dimethyl-1-pil-1-yl)methyl phenyl]titanium, bis(cyclopentadienyl)-bis[2,6-difluoro-3-((2,5-bis(morphorinomethyl)-1-pil-1-yl)methyl)phenyl]titanium, bis(cyclopentadienyl)-bis[2,6-difluoro-4-((2,5-dimethyl-1-pil-1-yl) methyl)phenyl]titanium, bis(cyclopentadienyl)-bis[2,6-difluoro-3-methyl-4-(2-(1-pil-1-yl)ethyl)phenyl]titanium, bis(cyclopentadienyl)-bis[2,6-difluoro-3-(1-methyl-2-(1-pil-1-yl) ethyl)phenyl]titanium, bis(cyclopentadienyl)-bis[2,6-difluoro-3-(6-(9-carbazole-9-yl)hexyl)phenyl]titanium, bis(cyclopentadienyl)-bis[2,6-difluoro-3-(3-(4,5,6,7-tetrahydro-2-methyl-1-indle-1-yl)propyl)phenyl]titanium, bis(cyclopentadienyl)-bis[2,6-difluoro-3-((acetylamino)methyl)phenyl]titanium, bis(cyclopentadiehyl)-bis[2,6-difluoro-3-(2-(propionylamino)ethyl) phenyl]titanium, bis(cyclopentadienyl)-bis[2,6-difluoro-3-(4-(pivaloylamino)butyl) phenyl]titanium, bis(cyclopentadienyl)-bis[2,6-difluoro-3-(2-(2,2-dimehylpentanoylamino) ethyl)phenyl]titanium, bis(cyclopentadienyl)-bis[2,6-difluoro-3-(3-(benzoylamino)propyl) phenyl]titanium, bis(cyclopentadienyl)-bis[2,6-difluoro-3-(2-(N-allylmethyl sulfonylamino)ethyl)phenyl]titanium, and bis(cyclopentadienyl)-bis(2,6-difluoro-3-(pyrrole-1-yl) phenyl)titanium. Each of these compounds may be used alone or in combination with two or more.

In addition, a commonly used photo-radical polymerization initiator may be used in combination with the titanocene derivative(s). The photo-radial polymerization initiator in combination with the titanocene derivative(s) in the present invention is not particularly limited as long as it is a compound generating radical by irradiation of light. Specific examples thereof include acetophenone or ketal photo-polymerization initiators such as diethoxyacetophenone, 2,2-dimethoxy-1,2-diphenylethane-1-on, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morphorinophenyl)butanone-1,2-hydroxy-2-methyl-1-phenylpropane-1-on, 2-methyl-2-morphorino(4-methylthiophenyl)propane-1-on, and 1-phenyl-1,2-propanedione-2-(o-ethoxycarbonyl)oxime; benzoin ether photo-polymerization initiators such as benzoin, benzoinmethyl ether, benzoin ethyl ether, benzoin isobutyl ether, and benzoin isopropyl ether; benzophenone photo-polymerization initiators such as benzophenone, 4-hydroxybenzophenon, methyl o-benzoyl benzoate, 2-benzoylnaphthalene, 4-benzoylbiphenyl, 4-benzoylphenyl ether, acrylated benzophenone, and 1,4-benzoylbenzene; thioxanthone photo-polymerization initiators such as 2-isopropyl thioxanthone, 2-chlorothioxanthone, 2,4-dimethylthioxanthone, 2,4-diethylthioxanthone, and 2-4-dichlorothioxanthone; and other photo-polymerization initiators include ethyl anthraquinone, 2,4,6-trimethyl benzoyl phenylphosphine oxide, 2,4,6-trimethylbenzoyl phenylethoxyphosphine oxide, bis(2,4,6-trimethylbenzoyl)phenylphosphine oxide, bis(2,4-dimethoxybenzoyl)-2,4,4-trimethylpentylphosphine oxide, methyphenyl glyoxyester, 9,10-phenanthrene, acridine compounds, triazine compounds, and imidazole compounds. Each of these photo-radial polymerization initiators may be used singularly in combination with the titanocene derivative(s) or two or more of them may be mixed for use in combination with the titanocene derivative(s).

In addition, each of compounds having photo-polymerization accelerating effect can be used alone or in combination with the photo-polymerization initiators. Examples of the compounds include triethanol amine, methyldiethanole amine, 4-dimethylamino ethyl benzoate, 4-dimethylamino isoamyl benzoate, ethyl benzoate (2-dimethylamino), and 4,4′-dimethylaminobenzophenone.

The content of the titanocene derivative and the polymerization initiator is 0.4 parts by mass to 40 parts by mass, and preferably 1 part by mass to 20 parts by mass relative to 100 parts by mass of the total radical polymerizable components constituting the surface layer.

—Trifunctional More Radical Polymerizable Monomer Having No Electric Charge Transportable Structure—

The trifunctional or more radical polymerizable monomer having no electric charge transportability used in the present invention represents a monomer which does not have, for example, an hole-transporting structure such as triarylamine, hydrazone, pyrazolone, and carbazole, and does not have, for example, an electron-transporting structure such as electron-sucking aromatic ring having condensed polycyclic quinine, diphenoquinone, cyano group, and nitro group, however, has three or more radical polymerizable functional groups. The radical polymerizable functional group is not particularly limited, provided that it is a group having a carbon-carbon double bond and is radical-polymerizable.

Examples of these radical polymerizable functional groups include 1-ethylene substituted functional groups, and 1,1-substituted ethylene functional groups shown below.

(1) Examples of the 1-substituted ethylene functional group include functional groups represented by the following General Formula (i).
CH₂═CH—X₁— General Formula (i)
In the General Formula (i), X₁ represents an arylene group that is allowed to have a substituted group (such as a phenylene group, and naphthylene group), an alkenylene group that is allowed to have a substituted group, —CO-group, —COO-group, —CON(R₁₀) -group (R₁₀ represents a hydrogen atom, an alkyl group such as methyl group, and ethyl group, or an aralkyl group such as benzyl group, naphthylmethyl group, and phenethyl group, or an aryl group such as phenyl group, and naphthyl group), or a S-group.

Specific examples of these substituted groups include vinyl group, styryl group, 2-methyl-1,3-butadienyl group, vinylcarbonyl group, acryloyloxy group, acryloylamide group, and vinylthioether group.

(2) Examples of the 1,1-substituted ethylene functional group include functional groups represented by the following General Formula (ii).
CH₂═C(Y)—X₂ General Formula (ii)

In the General Formula (ii), Y represents an alkyl group that is allowed to have a substituted group, an aralkyl group that is allowed to have a substituted group, an aryl group that is allowed to have a substituted group (such as a phenyl group and naphthyl group); or an alkoxy group such as halogen atom, cyano group, nitro group, methoxy group, or ethoxy group, —COOR₁₁ (R₁₁ represents a hydrogen atom, an alkyl group that is allowed to have a substituted group such as methyl group or ethyl group; aralkyl group that is allowed to have a substituted group such as benzyl group, phenethyl group, or aryl group that is allowed to have a substituted group such as phenyl group or naphthyl group), or CONR₁₂R₁₃ (CONR₁₂R₁₃ represents a hydrogen atom, an alkyl group that is allowed to have a substituted group such as benzyl group, naphthylmethyl group or phenethyl group, or an aryl group that is allowed to have a substituted group such as phenyl group and naphthyl group, and each of these groups may be the same or different from each other.

X₂ represents the same substituted group, a single bond, or an alkylene group as X₁. However, at least any one of Y and X₂ is an oxycarbonyl group, a cyano group, an alkenylene group, or an aromatic ring.

Specific examples of these substituted groups include α-acryloyloxy chloride group, methacryloyloxy group, α-cyanoethylene group, α-cyanoacryloyloxy group, α-cyanophenylene group, and methacryloylamino group.

Examples of substituted groups that are substituted by X₁, X₂, or Y include alkyl groups such as halogen atom, nitro group, cyano group, methyl group, and ethyl group; alkoxy groups such as methoxy group, and ethoxy group; aryloxy groups such as phenoxy group; aryl groups such as phenyl group, and naphthyl group; and aralkyl groups such as benzyl group, and phenethyl group.

Among these radical polymerizable functional groups, acryloyloxy group, and methacryloyloxy group are particularly effective, and the compound having three or more acryloyloxy groups can be obtained by subjecting, for example, a compound having 3 or more hydroxyl groups in the molecules, an acrylic acid (salt), an acrylic acid hydride, and an acrylic acid ester to an ester reaction or an ester exchange reaction. A compound having 3 or more methacryloyl groups can also be obtained in the same manner. Each of the radical polymerizable functional groups in the monomer having 3 or more radical polymerizable functional groups may be the same or different from each other.

Specific examples of the trifunctional or more radical polymerizable monomer having no electric charge transportable structure include the following compounds, however, it is not particularly limited to these compounds.

Examples of the radical polymerizable monomer used in the present invention include trimethylolpropane triacrylate (TMPTA), trimethylolpropane trimethacrylate, trimethylolpropane alkylene-modified triacrylate, trimethylol propane ethylene oxy-modified (EO-modified) triacrylate, trimethylolpropane propyleneoxy-modified (PO-modified) triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrine-modified (ECH-modified) triacrylate, glycerol EO-modified triacrylate, glycerol PO-modified triacrylate, tris(acryloxyethyl)isocyanurate, dipentaerithritol hexaacrylate (DPHA), dipentaerithritol caprolactone-modified hexaacrylate, dipentaerithritol hydroxypentaacrylate, alkylated dipentaerithritol pentaacrylate, alkylated dipentaerithritol tetraacrylate, alkylated dipentaerithritol triacrylate, dimethylolpropane tetraacrylate (DTMPTA), pentaerythritol ethoxytetraacrylate, phosphoric acid EO-modified triacrylate, and 2,2,5,5-tetrahydroxymethyl cyclopentanone tetraacrylate. Each of these may be used alone or in combination with two or more.

For the trifunctional or more radical polymerizable monomer having no electric charge transportable structure used in the present invention, a dense crosslinking bond is formed in the crosslinked surface layer, the ratio of molecular mass relative to the number of functional groups (molecular mass/the number of functional group) in the monomer is preferably 250 or less. When the ratio is greater than 250, the crosslinked surface layer is soft, and the abrasion resistance is degraded in some degree, and thus for monomers having a modified group such as EO, PO, and caprolactone among the above-noted monomers, it is unfavorable to use a compound having an extremely long modified group alone. For the component ratio of the trifunctional or more radical polymerizable monomer having no electric charge transportable structure, which is used for the surface layer, the content in the solid content of the coating solution is adjusted so as to be 20% by mass to 80% by mass, preferably be 30% by mass to 70% by mass relative to the total amount of the crosslinked surface layer. When the content of the monomer component is less than 20% by mass, the three-dimensionally crosslinked bonding density of the crosslinked surface layer is low, and it is difficult to achieve a drastic improvement in abrasion resistance, compared to the case where a conventional thermoplastic binder resin is used. When the content of the monomer is more than 80% by mass, the content of the electric charge transportable compound is lowered to cause degradation of electric properties. The content of the monomer cannot be defined exactly because required abrasion resistance and electric properties differ depending on the used process, however, in consideration of balance of both of the properties, it is particularly preferably ranging from 30% by mass to 70% by mass.

—Trifunctional or More Radical Polymerizable Monomer Having an Electric Charge Transportable Structure—

The trifunctional or more radical polymerizable monomer having an electric charge transportable structure used in the present invention represents a compound having, for example, an hole-transporting structure such as triarylamine, hydrazone, pyrazolone, and carbazole, and an electron-transporting structure such as electron-sucking aromatic ring having condensed polycyclic quinine, diphenoquinone, cyano group, and nitro group, and having a radical polymerizable functional group. Examples of the radical polymerizable functional group include those described above in the radical polymerizable monomer, and acryloyloxy group, and methacryloyloxy group are particularly effective. The number of radical polymerizable functional groups per molecule may be one or more or may be plural, however, to restrain internal stress of the crosslinked surface layer to make it ease to obtain smooth surface property and to maintain excellent electric properties, one molecule of the monomer preferably has one radical polymerizable functional group. However, the present invention achieves obtaining a smooth and uniform crosslinked surface layer by using a titanocene derivative as a photo-polymerization initiator and selecting a light energy emission wavelength, and even when the electric charge transportable compound has two or more radical polymerizable functional groups, it is possible to achieve a crosslinked surface layer having highly crosslinked density without having distortion inside the crosslinked layer. Using the surface layer, it is possible to provide an electrophotographic photoconductor which will have less surface abrasion and flaws and maintain electric properties even with long-term use. For the electric charge transportable structure of the radical polymerizable monomer having an electric charge transportable structure, triarylamine structures are preferable in terms of high-migratory property. Of these, when a compound represented by the following General Formula (1) or General Formula (2) is used, electric properties such as sensitivity, and residual potential can be efficiently maintained. 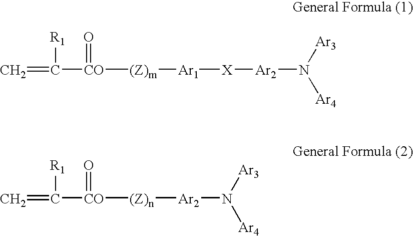
[In the General Formulas (1) and (2), R₁ represents a hydrogen atom, a halogen atom, an alkyl group that is allowed to have a substituted group, an aralkyl group that is allowed to have a substituted group, an aryl group, a cyano group, a nitro group, or an alkoxy group that is allowed to have a substituted group, or —COOR₇ (R₇ represents a hydrogen atom, a halogen atom, an alkyl group that is allowed to have a substituted group, an aralkyl group that is allowed to have a substituted group, or an aryl group that is allowed to have a substituted group), a halogenated carbonyl group or CONR₈R₉ (R₈ and R₉ respectively represents a hydrogen atom, a halogen atom, an alkyl group that is allowed to have a substituted group, an aralkyl group that is allowed to have a substituted group, or an aryl group that is allowed to have a substituted group; and each of these groups may be the same or different from each other). Ar₁ and Ar₂ respectively represent a substituted or unsubstituted arylene group and may be the same or different from each other. Ar₃ and Ar₄ respectively represent a substituted or unsubstituted aryl group and may be the same or different from each other. X represents a single bond, a substituted or unsubstituted alkylene group, a substituted or unsubstituted cycloalkylene group, a substituted or unsubstituted alkylene ether divalent group, oxygen atom, a sulfur atom, or a vinylene group. Z represents a substituted or unsubstituted alkylene group, a substituted or unsubstituted alkylene ether divalent group or an alkyleneoxycarbonyl divalent group. “m” and “n” respectively represent an integer of 0 to 3.].

Materials having a triarylamine structure as described above are extremely excellent in electric charge transportability, however, at the same time, they have an light absorption edge (light absorption peak) at a relatively longwavelength (specifically, at a wavelength of 300 nm or more), and therefore, when such a material is used for the photo-crosslinkable surface layer, it is feared that light absorption will inhibit crosslinking, however when the titanocene derivative described in the present invention is used, it was possible to obtain a crosslinked film (layer) in a uniformly cured state from the layer surface through to the inside of the layer.

The relation between the absorption edge wavelength HA (nm) in the light absorption spectrum of the radical polymerization initiator and the absorption edge wavelength HB (nm) in the light absorption spectrum of the radical polymerizable monomer having an electric charge transportable structure is represented by HA>HB, satisfies HA−HB>40 nm and preferably HA−HB>60 nm.

When the value of HA−HB is less than 40 nm or less, almost all absorption wavelengths of titanocene derivatives agree with those of radical polymerizable monomers having an electric charge transportable structure, and it is unfavorable because crosslinking failures may occur along with reduction of radical generation efficiency.

When a surface layer is photo-crosslinked by using a titanocene derivative described in the present invention and a compound having a light absorption edge wavelength of 370 nm or more is used, it was possible to verify the superiority of the titanocene derivative to other photo-radial polymerizable initiators, and particularly when a compound having a light absorption edge wavelength of 400 nm or more is used, the superiority was obvious.

In the General Formulas (1) and (2), in the substituted group of R₁, examples of the alkyl groups include methyl group, ethyl group, propyl group, and butyl group; examples of the aryl groups include phenyl group, and naphthyl group; examples of the aralkyl groups include benzyl group, phenethyl group, and naphthylmethyl group; examples of the alkoxy group include methoxy group, ethoxy group, and propoxy group, respectively, each of these groups may be substituted by an alkyl group such as halogen atom, nitro group, cyano group, methyl group, and ethyl group; an alkoxy group such as methoxy group, and ethoxy group; an aryloxy group such as phenoxy group; an aryl group such as phenyl group, and naphthyl group; or an aralkyl group such as phenethyl group.

Among the substituted group of R₁, a hydrogen atom, and a methyl group are particularly preferable.

Ar₃ and Ar₄ are respectively a substituted or unsubstituted aryl group, and examples of the aryl group include condensed polycyclic hydrocarbon groups, non-condensed cyclic hydrocarbon groups, and heterocyclic groups.

The condensed polycyclic hydrocarbon group is preferably the one that the carbon atoms forming a ring is 18 or less, and examples thereof include pentanyl group, indenyl group, naphthyl group, azulenyl group, heptalenyl group, biphenylenyl group, a s (asym)-indacenyl group, s(sym)-indacenyl group, fluorenyl group, acenaphthylenyl group, playadenyl group, acenaphtenyl group, phenalenyl group, phenanthryl group, anthryl group, fluoranthenyl group, acephenantolylenyl group, aceanthrylenyl group, triphenylel group, pyrenyl group, crycenyl group and a naphthacenyl group.

Examples of the non-condensed cyclic hydrocarbon group include monovalent groups of monocyclic hydrocarbon compound such as benzene, diphenylether, polyethylene diphenylether, or monovalent groups of non-condensed polycyclic hydrocarbon compound such as biphenyl, polyphenyl, diphenylalkane, diphenylalkene, diphenylalkyne, triphenylmethane, distyrylbenzene, 1,1-diphenylcycloalkane, polyphenylalkane, and polyphenylalkene; or monovalent groups of ring aggregating hydrocarbon compound such as 9,9-diphenylfluorene.

Examples of the heterocyclic group include carbazole, dibenzofuran, dibenzothiophene, oxadiazole, and thiadiazole.

The aryl group represented by Ar₃ or Ar₄ may have a substituted group, for example, as shown below:

(1) halogen atom, cyano group, nitro group, etc.

(2) alkyl groups; straight chain or branched chain alkyl group preferably having 1 to 12 carbon atoms, more preferably having 1 to 8 carbon atoms, and further preferably having 1 to 4 carbon atoms, and each of these alkyl groups may have a phenyl group further substituted by fluorine atom, hydroxyl group, cyano group, alkoxy group having 1 to 4 carbon atoms, phenyl group or halogen atom, alkyl group having 1 to 4 carbon atoms, or alkoxy group having 1 to 4 carbon atoms. Specific examples thereof include methyl group, ethyl group, n-butyl group, i-propyl group, t-butyl group, s-butyl group, n-propyl group, trifluoromethyl group, 2-hydroxyethyl group, 2-ethoxyethyl group, 2-cyanoethyl group, 2-methoxyethyl group, benzyl group, 4-chlorobenzyl group, 4-methylbenzyl group, and 4-phenylbenzyl group.

(3) alkoxy groups (—OR₂); R₂ represents the alkyl group defined in (2). Specific examples thereof include methoxy group, ethoxy group, n-propoxy group, i-propoxy group, t-buthoxy group, n-buthoxy group, s-buthoxy group, 2-hydroxyethoxy group, benzyloxy group, and trifluoromethoxy group.

(4) aryloxy groups; examples of aryl group include phenyl group, and naphthyl group, and each of them may contain an alkoxy group having 1 to 4 carbon atoms, an alkyl group having 1 to 4 carbon atoms, or a halogen atom as a substituted group. Specific examples thereof include phenoxy group, 1-naphthyloxy group, 2-naphthyloxy group, 4-methoxyphenoxy group, and 4-methylphenoxy group.

(5) alkylmercapto groups or arylmercapto groups; specific examples thereof include methythio group, ethylthio group, phenylthio group, and p-methylphenylthio group.

(6) Substituted groups represented by the following formula:

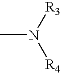

In the above formula, R₃ and R₄ individually represent a hydrogen atom, an alkyl group defined as above in (2), or an aryl group. Examples of the aryl group include phenyl groups, biphenyl groups, or naphthyl groups, and each of them may contain an alkoxy group having 1 to 4 carbon atoms, an alkyl group having 1 to 4 carbon atoms, or a halogen atom as a substituted group. R₃ and R₄ may jointly form a ring.

Specific examples thereof include amino group, diethylamino group, N-methyl-N-phenylamino group, N,N-diphenylamino group, N,N-di(tlyl)amino group, dibenzylamino group, piperidine group, morphorino group, and pyrrolidino group.

(7) methylenedioxy group, or alkylenedioxy group such as methylene dithio group, or alkylene dithio group.

(8) substituted or unsubstituted styryl groups, substituted or unsubstituted β-phenylstyryl groups, diphenylaminophenyl groups, and ditolylaminophenyl groups.

Meanwhile, the arylene group represented by the Ar₁ or Ar₂ is a divalent group induced from the aryl group represented by the Ar₃ or Ar₄.

The above-noted X represents a single bond, a substituted or unsubstituted alkylene group, a substituted or unsubstituted cycloalkylene group, a substituted or unsubstituted alkylene ether group, oxygen atom, sulfur atom, or a vinylene group.

The substituted or unsubstituted alkylene group is a straight chain or branched chain alkylene group typically having 1 to 12 carbon atoms, preferably having 1 to 8 carbon atoms, and more preferably having 1 to 4 carbon atoms, and each of these alkylene group may contain a phenyl group further substituted by fluorine atom, hydroxy group, cyano group, alkoxy group having 1 to 4 carbon atoms, phenyl group, or halogen atom, alkyl group having 1 to 4 carbon atoms or alkoxy group having 1 to 4 carbon atoms. Specific examples thereof include methylene group, ethylene group, n-butylene group, i-propylene group, t-butylene group, s-butylene group, s-butylene group, n-propylene group, trifluoromethylene group, 2-hydroxyethylene group, 2-ethoxyethlene group, 2-cyanoethylene group, 2-methoxyethylene group, benzylidene group, phenylethylene group, 4-chlorophenylethylene group, 4-methylphenylethylene group, and 4-biphenylethylene group.

The substituted or unsubstituted cycloalkylene groups are cyclic alkylene groups having 5 to 7 carbon atoms, and each of these cyclic alkylene groups may contain fluorine atom, hydroxyl group, alkyl group having 1 to 4 carbon atoms, or alkoxy group having 1 to 4 carbon atoms. Specific examples thereof include cyclohexylidene group, cyclohexylene group, and 3,3-dimethylcyclohexylidene group.

Examples of the substituted or unsubstituted alkylene ether divalent groups include alkylene oxy divalent group such as ethylene oxy group, and propylene oxy group; or alkylene dioxy divalent groups induced from ethylene glycol or propylene glycol; or di(oxyalkylene)oxy divalent group or poly(oxyalkylene)oxy divalent group which are induced from diethylene glycol, tetraethylene glycol, tripropylene glycol, etc., and the alkylene group of alkylene ether divalent group may contain a substituted group such as hydroxyl group, methyl group, and ethyl group.

The vinylene group is represented by any one of the following formulas:

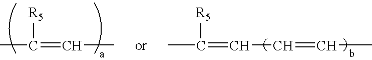

In the above formulas, R₅ represents a hydroxyl group, an alkyl group (same as alkyl groups defined in (2)), an aryl group (same as aryl groups represented by the Ar₃ or Ar₄); “a” is an integer of 1 or 2, and “b” is an integer of 1 to 3.

“Z” represents a substituted or unsubstituted alkylene group, a substituted or unsubstituted alkylene ether divalent group, or an alkyleneoxycarbonyl divalent group.

Examples of the substituted or unsubstituted alkylene group include the same alkylene groups as those described in the “X”.

Examples of the substituted or unsubstituted alkylene ether divalent group include the same alkylene ether divalent groups as those described in the “X”.

Examples of the alkyleneoxycarbonyl divalent group include caprolactone-modified divalent groups.

More preferably used radical polymerizable monomers having an electric charge transportable structure in the present invention include compounds represented by the following General Formula (3).

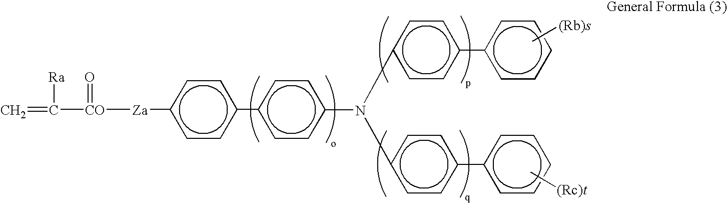

In the General Formula (3), “o”, “p”, “q” respectively represent an integer of 0 or 1; Ra represents a hydrogen atom, or a methyl group; Rb and Rc respectively represent an alkyl group having 1 to 6 carbon atoms, and when they respectively have a plurality of alkyl groups, the alkyl groups may be different from each other. “s” and “t” respectively represent an integer of 0 to 3. Za represents a single bond, methylene group, ethylene group or any one of compounds represented by one of the following formulas:

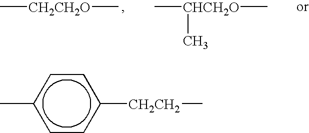

For compounds represented by the above general formulas, as substituted groups of Rb or Rc, compounds substituted by methyl group, or ethyl group are particularly preferable.

Since the radical polymerizable monomer having an electric charge transportable structure, which is represented by General Formula (1), or General Formula (2), or in particular, General Formula (3) in the present invention is polymerized in a state where a carbon-carbon double bond opens at the both sides thereof, the radical polymerizable monomer will not take a terminate structure, however, will be incorporated into a chain polymer. In a polymer formed and crosslinked by polymerization with a trifunctional or more radical polymerizable monomer, the electric charge transportable structure exists in the main chain of one high-molecule and exists in a crosslinked chain between one main chain and one main chain (the crosslinked chain has an inter-molecular crosslinked chain between one high-molecule and another high-molecule, and an intramolecular crosslinked chain in which a certain site of a main chain being folded within one high molecule is crosslinked with another site within the main chain, the another site being derived from a monomer that has been polymerized at a position away from the another site), however, even when the electric charge transportable structure exists in the main chain or even when the electric charge transportable structure exists in a crosslinked chain, a triarylamine structure suspended from the chain region has at least three aryl groups located in radial directions from a nitrogen atom, and the triarylamine structure is not directly bonded to the chain region, and is suspended from the chain region through a carbonyl group or the like, it is bulky, though. Because the triarylamine structure is fixed in a state where it is three-dimensionally positioned with flexibility, it allows a spacial configuration in which these triarylamine structures are moderately situated close to each other in a polymer. Therefore, there is less structural distortion within a molecule, and when it is used for a surface layer of an electrophotographic photoconductor, it is assumed that it takes an intramolecular structure relatively escaping disconnection of electric charge transporting channels. Further, with a view to further improvement of abrasion resistance in the present invention, an electric charge transportable compound having two or more radical polymerizable functional groups can be preferably used. In conventional techniques, when an electric charge transportable compound having two or more radical polymerizable functional group is used, bulky electric charge transportable structures are fixed through a plurality of bonds in a crosslinked bond, distortions arise inside the crosslinked film (layer), and there is a tendency that cracks and film exfoliations easily occur because of the increased internal stress. In contrast, in the present invention, the use of a titanocene derivative as a photo-polymerization initiator enabled curing a surface layer through to the inside of the layer, achieving a uniformly crosslinked surface layer without causing distortion inside the crosslinked surface layer, and achieving a crosslinked surface layer having higher crosslinking densities. Since no distortion is induced inside the crosslinked layer, it is possible to stably keep intermediate structures (cation radical) in transporting electric charge, degradations of sensitivity and increases in residual potential resulting from electric charge trap rarely occur, and it also enables for an electrophotographic photoconductor to maintain stable electric properties over a long period of time.

Hereinafter, specific examples of the radical polymerizable monomer having an electric charge transportable structure which has an triarylamine structure as an electric charge transportable structure will be described, however, the radial polymerizable monomer is not limited to the compounds having these structures.

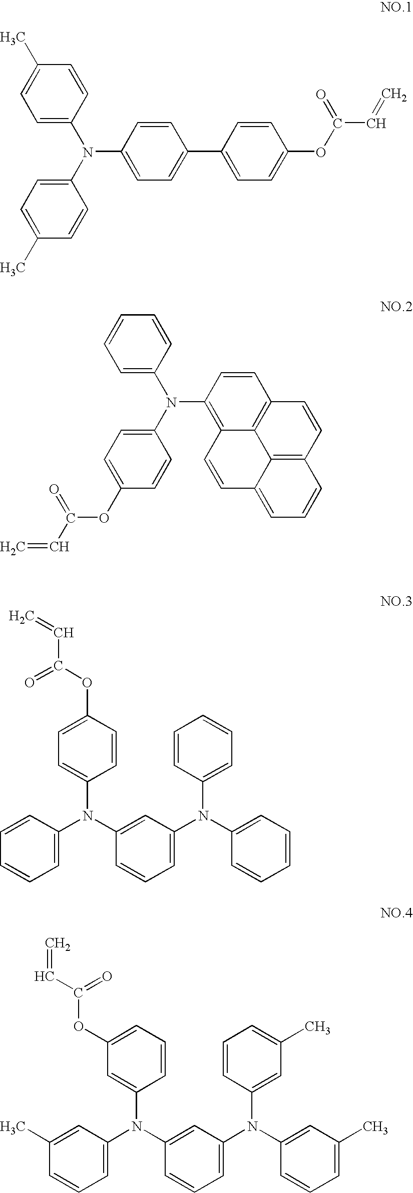

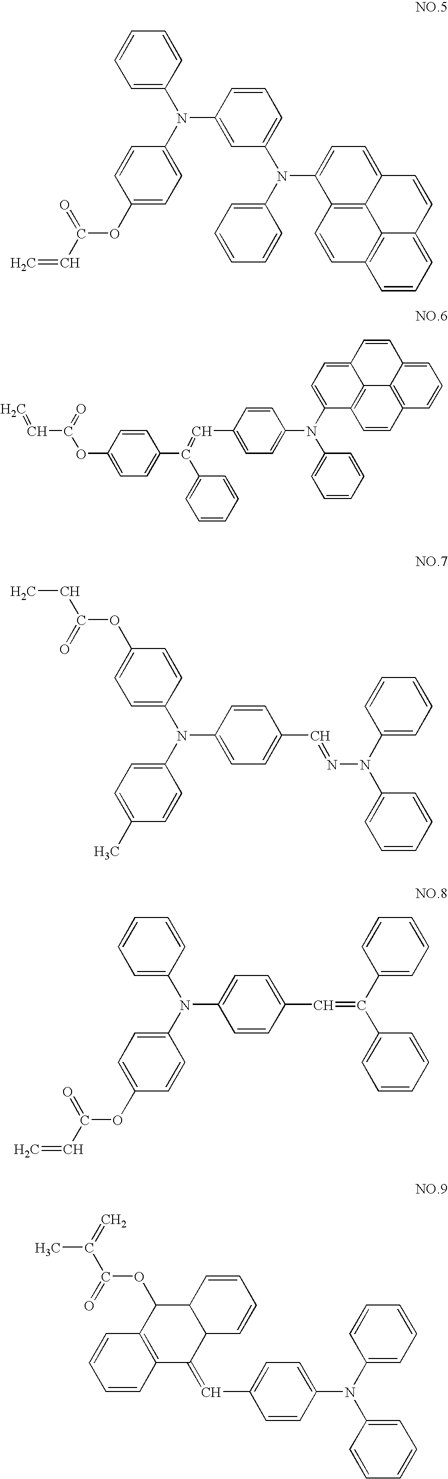

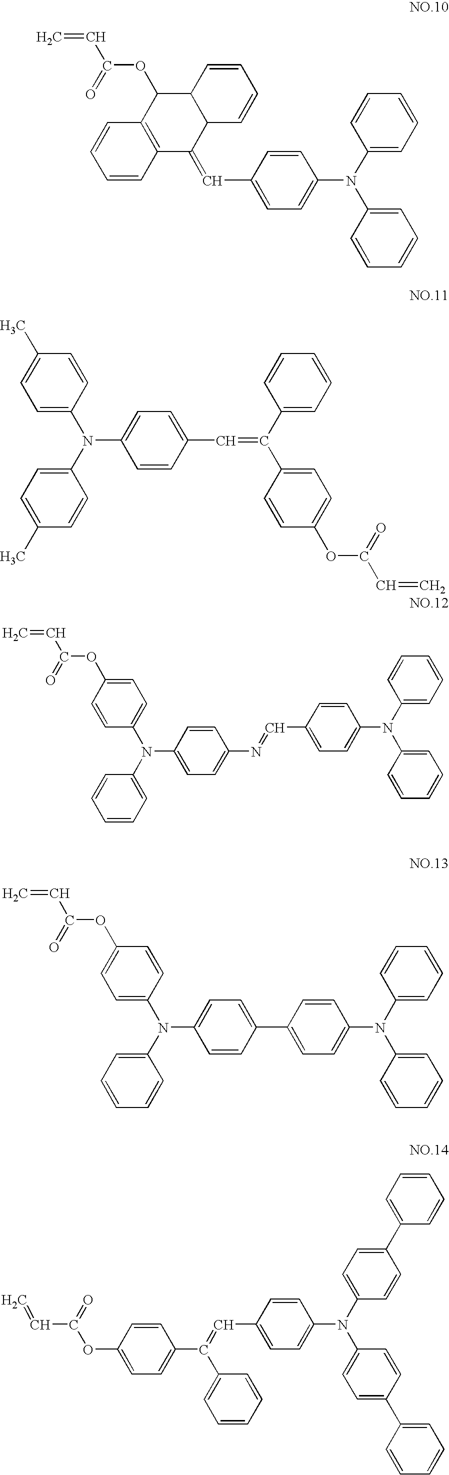

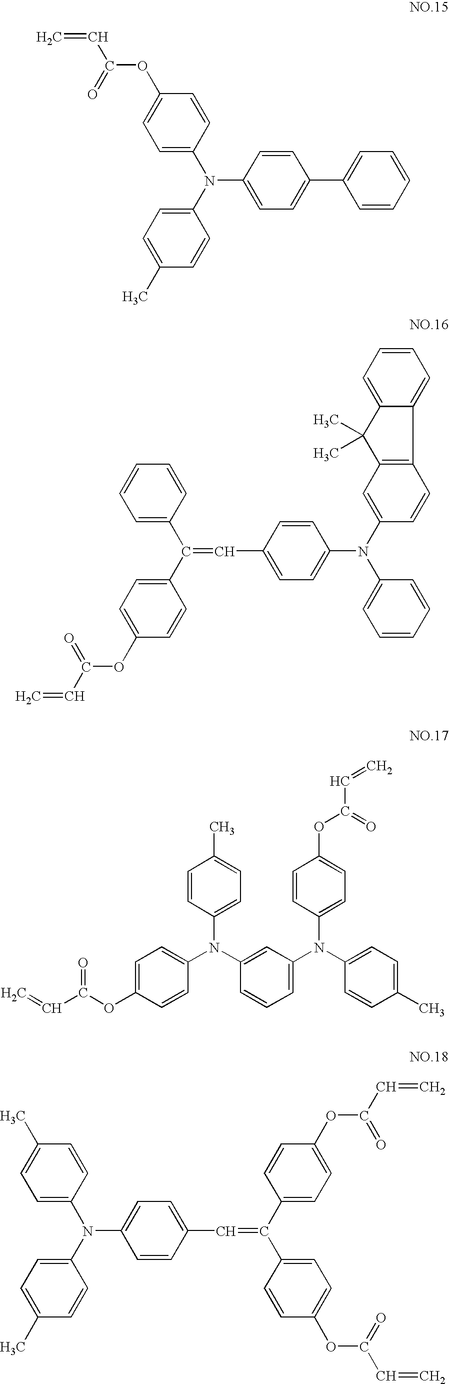

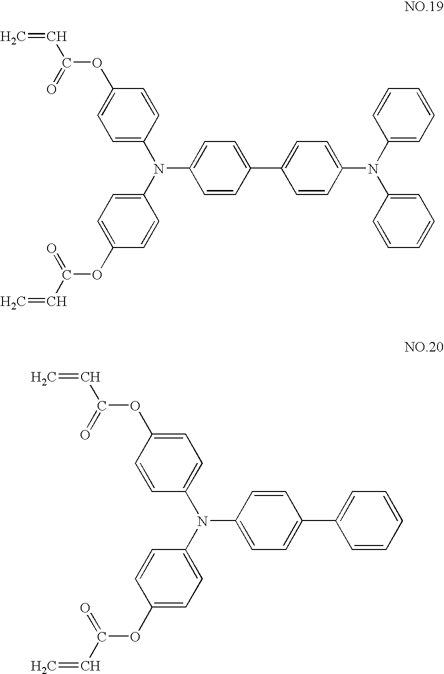

In the present invention, a specific acryl ester compound shown in the following General Formula (4) can also be preferably used as a radical polymerizable monomer having an electric charge transportable structure.
B₁—Ar₁—CH═CH—Ar₂—B₂ General Formula (4)

In the General Formula (4), Ar₁ represents a monovalent group or a divalent group which contains a substituted or unsubstituted aromatic hydrocarbon skeleton. Examples of the aromatic hydrocarbon include benzene, naphthalene, phenanthrene, biphenyl, and 1,2,3,4-tetrahydronaphthalene. Examples of the substituted group include an alkyl group having 1 to 12 carbon atoms, an alkoxy group having 1 to 12 carbon atoms, a benzyl group, and a halogen atom. The alkyl groups and alkoxy groups may further have a halogen atom and a phenyl group as a substituted group.

Ar₂ represents a monovalent group or a divalent group which contains an aromatic hydrocarbon skeleton having at least one tertiary amino group, or a monovalent group or a divalent group which contains a heterocyclic compound having at least one tertiary amino group, and the aromatic hydrocarbon skeleton having a tertiary amino group is represented by the following General Formula (8).

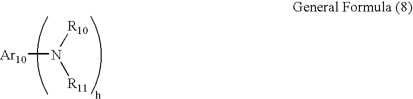

In the General Formula (8), R₁₀ and R₁₁ respectively represent an acyl group, a substituted or unsubstituted alkyl group, or a substituted or unsubstituted aryl group. Ar₁₀ represents an aryl group, and “h” is an integer of 1 to 3.

Examples of the acyl group of R₁₀ and R₁₁ include acetyl groups, propionyl groups, and benzoyl groups. The substituted or unsubstituted alkyl group of R₁₀ and R₁₁ are same as the alkyl groups described in the substituted group of Ar₁. The substituted or unsubstituted aryl group of R₁₀ and R₁₁ can include groups represented by the following General Formula (9), besides phenyl groups, naphthyl groups, biphenyl groups, terphenylyl groups, pyrenyl groups, fluorenyl groups, 9,9-dimethyl-2-fluorenyl groups, azurenyl groups, anthryl groups, triphenylenyl groups, and chrysenyl groups.

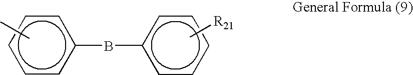

In the General Formula (9), B is selected from —O—, —S—, —SO—, —SO₂—, —CO—, and divalent groups represented by the following formula.

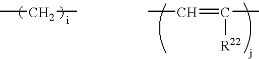

In the above formula, R²¹ represents a hydrogen atom, a substituted or unsubstituted alkyl group defined in Ar₁, an alkoxy group, a halogen atom, a substituted or unsubstituted aryl group defined in R₁₀, an amino group, a nitro group, or a cyano group; R²² represents a hydrogen atom, a substituted or unsubstituted alkyl group defined in Ar₁, or a substituted or unsubstituted aryl group defined in R₁₀; “i” is an integer of 1 to 12; and “j” is an integer of 1 to 3.

Specific examples of the alkoxy group of R²¹ include methoxy group, ethoxy group, n-propoxy group, 1-propoxy group, n-buthoxy group, i-buthoxy group, s-buthoxy group, t-buthoxy group, 2-hydroxyethoxy group, 2-cyanoethocy group, benzyloxy group, 4-methylbenzyloxy group, and trifluoromethoxy group.

Examples of the halogen atom of R²¹ include fluorine atom, chlorine atom, bromine atom, and iodine atom.

Examples of the amino group of R²¹ include diphenylamino group, ditolylamino group, dibenxylamino group, and 4-methylbenzyl group.

Examples of the aryl group of Ar₁₀ include phenyl group, naphthyl group, biphenylyl group, terphenylyl group, pyrenyl group, fluorenyl group, 9,9-dimethyl-2-fluorenyl group, azurenyl group, anthryl group, triphenylenyl group, and chrysenyl group.

Ar₁₀, R₁₀, and R₁₁ may contain alkyl groups, alkoxy groups, and halogen atom defined in the substituted group of Ar₁.

Examples of the heterocyclic compound skeleton having a tertiary amino group include heterocyclic compounds having an amine structure such as pyrrole, pyrazole, imidazole, triazole, dioxazole, indole, isoindole, benzimidazole, benzotriazole, benzoisoxazine, carbazole, and pheoxazine. Each of these heterocyclic compounds may contain alkyl groups, alkoxy groups, and halogen atom defined in the substituted group of Ar₁.

B₁ and B₂ respectively represent an acryloyloxy group, a methacryloyloxy group, a vinyl group, an alkyl group having an acryloyloxy group or a methacryloyloxy group or a vinyl group, or an alkoxy group having an acryloyloxy group or a methacryloyloxy group or a vinyl group. For the alkyl group and the alkoxy group, those described in the Ar₁ are used. For the B₁ and B₂, either B₁ or B₂ exists in the heterocyclic compound skeleton, and presence of both B₁ and B₂ is excluded.

Examples of more preferred structure for the acrylic acid ester compound of the General Formula (4) can include the compounds represented by the following General Formula (5).

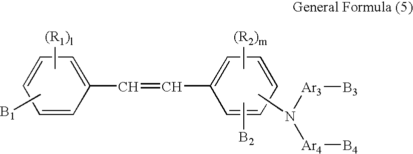

In the General Formula (5), R₁ and R₂ respectively represent a substituted or unsubstituted alkyl group, a substituted or unsubstituted alkoxy group, or a halogen atom; Ar₃ and Ar₄ respectively represent a substituted or unsubstituted aryl group or arylene group, or a substituted or unsubstituted benzyl group. For the alkyl group, alkoxy group, and halogen atom, those described in the Ar₁ are used.

The aryl groups are the same as those defined in the R₁₀ and R11. The arylene group is a divalent group induced from the aryl groups.

B₁, B₂, B₃, and B₄ in the General Formula (5) are the same as those defined for B₁, B₂, and just one of B₁ to B₄ exists in the acrylic acid ester compound, and presence of two or more is excluded. “l” is an integer of 0 to 5, and “m” represents an integer of 0 to 4.

A specific acrylic ester compound has the following characteristic. It is a tertiary amine compound having a stilbene conjugate structure and has a developed conjugate system. By using an electric charge transportable compound having such a developed conjugate system, the interface of a crosslinked layer has extremely favorable electric charge infusion property. Further, when the stilbene conjugate structure is fixed into the crosslinked bond, the intermolecular interaction is hardly inhibited, excellent properties on electric charge mobility can be held. The specific acrylic acid ester has one highly radical-polymerized acryloyloxy group or methacryloyloxy group in a molecule, it is immediately gelatinized at the time of radical polymerization and does not cause excessive distortion resulting from crosslinking. Double bonds in the stilbene structural part in the molecule partially participate in the polymerization, and time lag occurs in the crosslinking reaction because the polymerizability of stilbene group is lower than those of acryloyloxy group or methacryloyloxy group, and thus the compound will not maximize the distortion degree, and the use of double bonds in the molecules makes it possible to increase the number of crosslinking reactions per molecule. Accordingly, it is expected to enhance the crosslinking density and to further improve abrasion resistance. In addition, the use of double bond allows adjusting the polymerization degree depending on the crosslinking conditions and allows easy preparation of an optimum crosslinking film. The participation in radical polymerization like this is a specific characteristic of acrylic acid ester compounds and does not occur in an α-phenylstilbene structure stated above.

As other characteristics of acrylic acid ester compounds, acrylic acid ester compounds have a tendency to shift the light absorption edge to longer wavelengths because of its developed conjugate system, compared to other compounds. For triarylamine materials as described in the General Formula (6), many of them have a light absorption edge exceeding 400 nm, and when a triarylamine material is used for the crosslinked surface layer, difference in crosslinked condition is easily induced between the layer surface and the inside of the layer because of the above noted light absorption property. However, when the titanocene derivative described in the present invention is used, the light absorption edge thereof is often at a longer wavelength than those of the acrylic acid ester compounds, and thus it is possible to obtain a cured layer uniformly formed ranging over the entire layer.

Based on the above mentioned, by using, in particular, a radical polymerizable monomer having an electric charge transportable structure shown in the General Formula (5) in combination with the titanocene derivative described in the present invention, it is possible to form a film having an extremely high crosslinking density without substantially causing occurrences of cracks while maintaining excellent electric properties thereby satisfying various properties of photoconductors and to provide an excellent electrophotographic photoconductor which will not cause abrasion and flaws and hardly cause image defects over a long period of time.

Hereinafter, specific examples of the radical polymerizable monomer having an electric charge transportable structure shown in the General Formula (4) will be described, the radical polymerizable monomer having an electric charge transportable structure is not limited to the compounds having these structure.

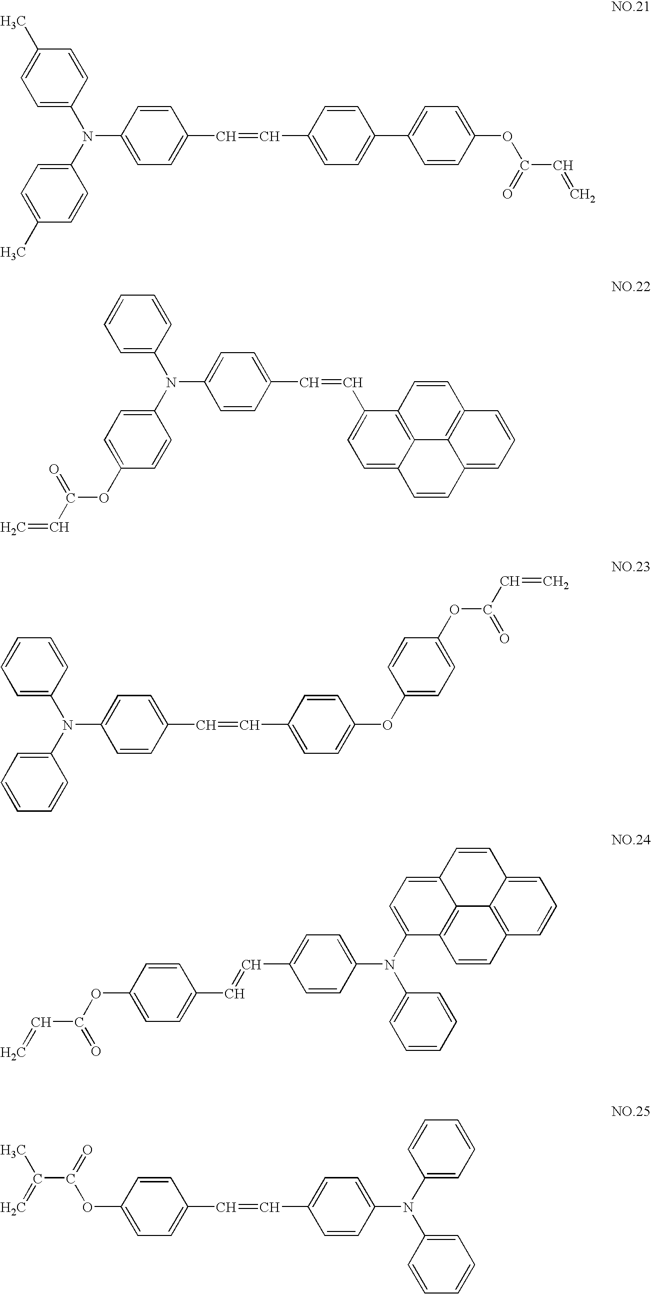

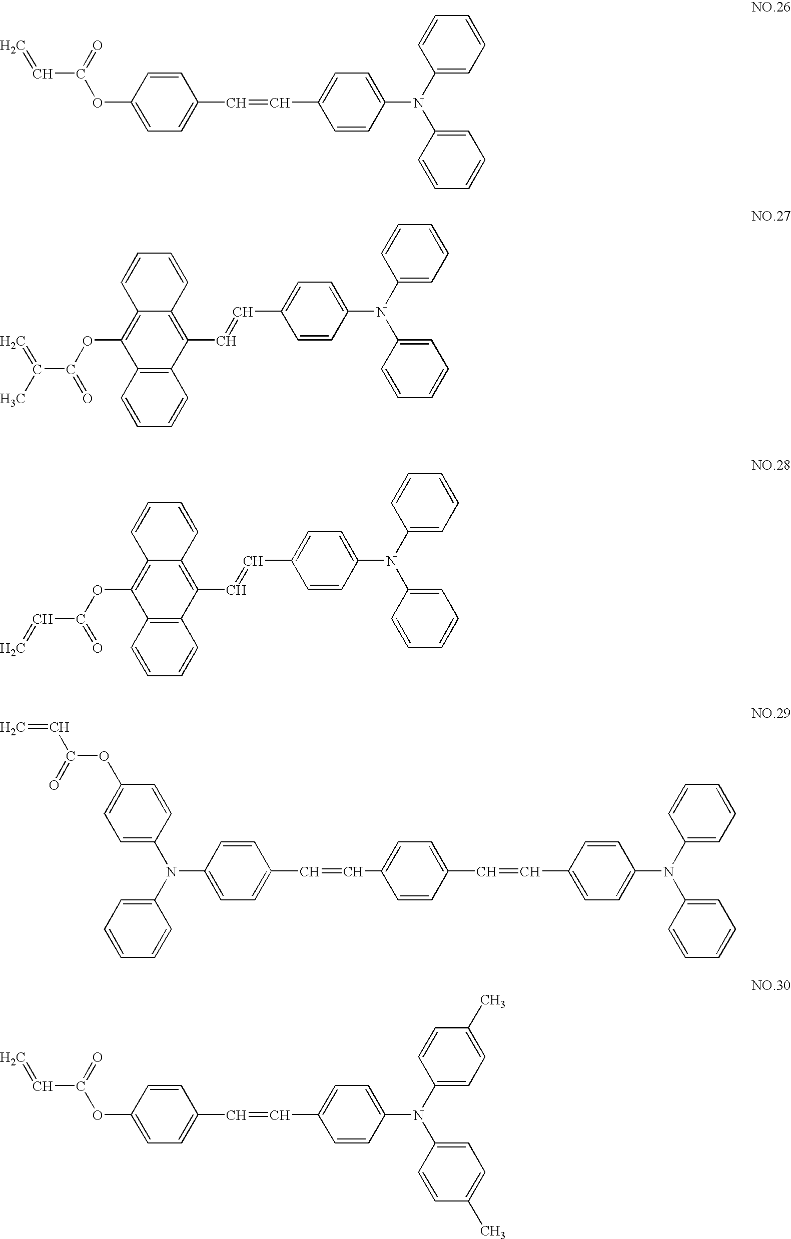

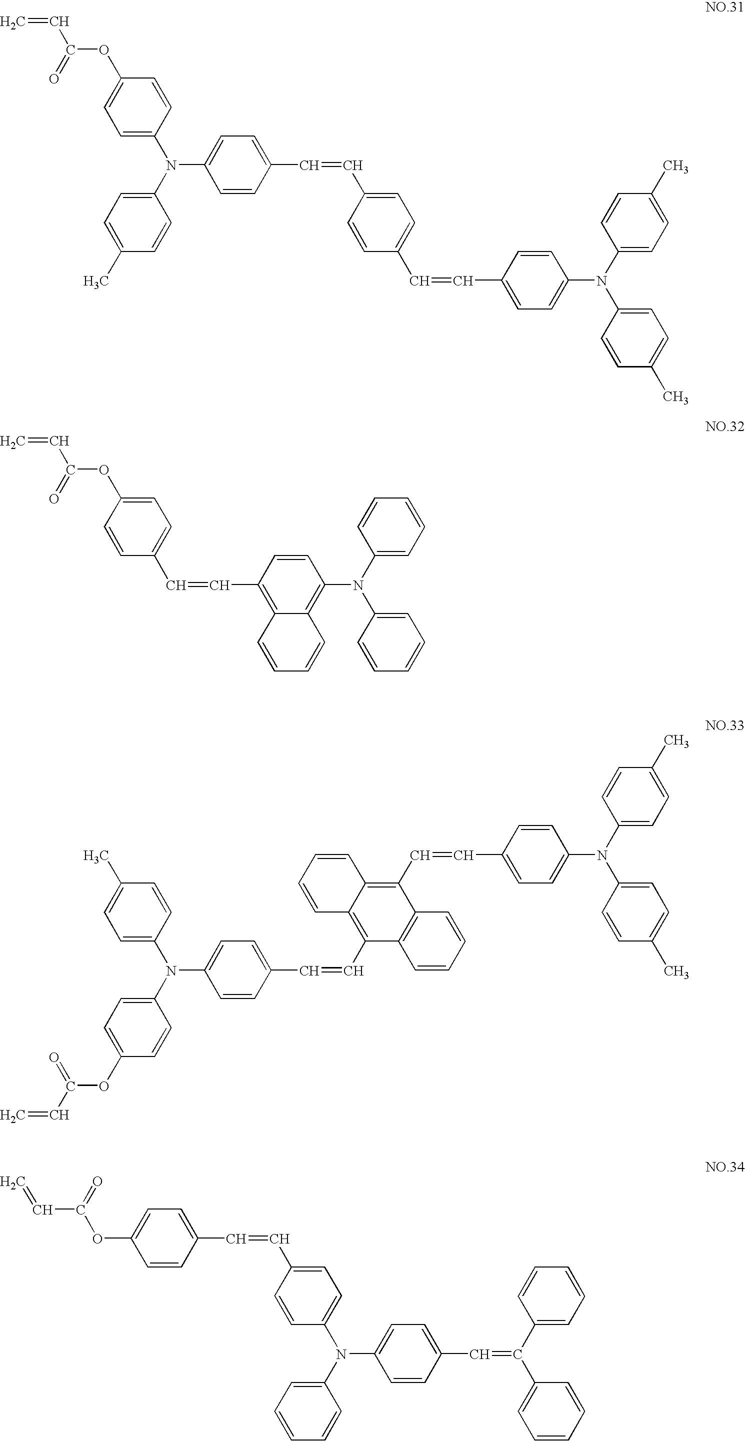

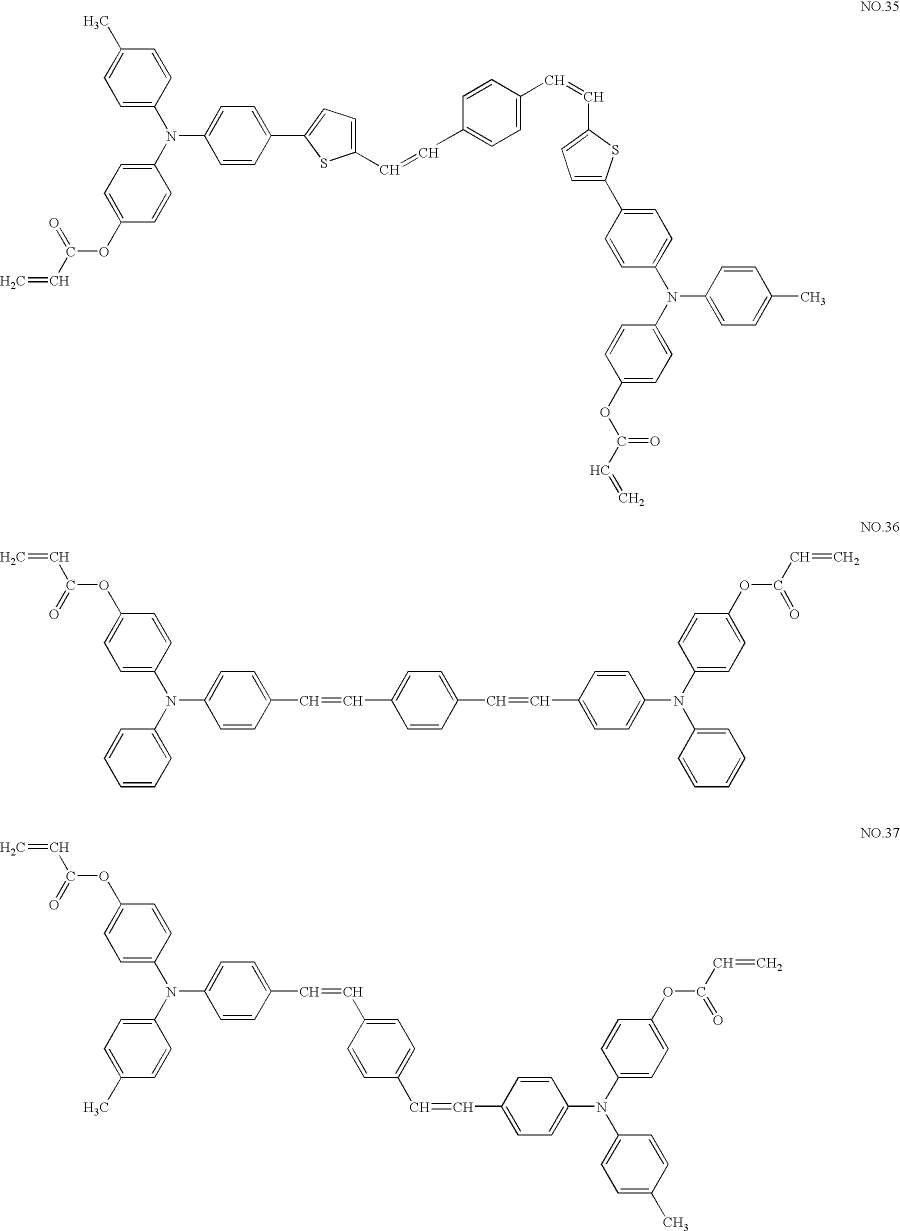

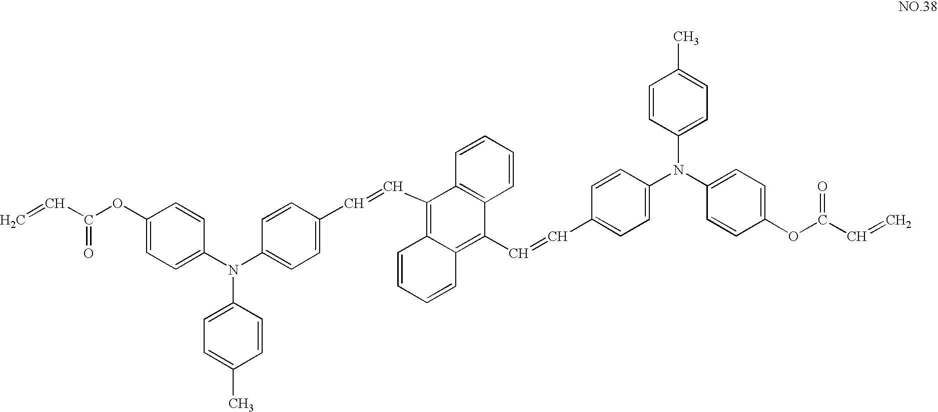

The radical polymerizable monomer having an electric charge transportable structure used in the present invention is important to impart electric charge transportability to the crosslinked surface layer, and the content of the component is adjusted such that the content of the coating solution thereof is 20% by mass to 80% by mass, more preferably 30% by mass to 70% by mass relative to the total mass of the crosslinked surface layer. When the content of the component is less than 20% by mass, the electric charge transportability of the crosslinked surface layer cannot be sufficiently maintained, and when used repetitively, it leads to degradations of electric properties such as degradation of sensitivity, and increase in residual potential. When the content of the radical polymerizable monomer is more than 80% by mass, the content of the tertiary monomer having no electric charge transportable structure is reduced, and this leads to a reduction of crosslinking bond density, and high-abrasion resistance cannot be exhibited. Required electric properties and abrasion resistance differ depending to the process to be used and cannot be defined exactly, however, in consideration of the balance of both properties, the content of the radical polymerizable monomer having an electric charge transportable structure is particularly preferably 30% by mass to 70% by mass.

The coating solution used in the present invention may further contain additives such as various plasticizers (for the purpose of alleviation of stresses and improving adhesiveness), leveling agents, and low-molecular electric charge transportable materials having no radical reactivity. For these additives, those known in the art can be used. For the plasticizers, those used in common resins such as dibutylphthalate, dioctylphthalate can be used, and the usage of the plasticizers is restricted to 20 parts by mass or less, preferably to 10 parts by mass or less relative to the total solid content of the coating solution. For the leveling agents, silicone oils such as dimethyl silicone oil, and methylphenyl silicone oil, polymers or oligomers having a perfluoroalkyl group at the side chains thereof can be utilized, and the appropriate usage is 3 parts by mass or less relative to the total solid content of the coating solution.

When the trifunctional or more radical polymerizable monomer and the radical polymerizable compound having an electric charge transportable structure are formed on a photosensitive layer, it is preferred to make the coating solution to have low viscosity to retain flowability. Provided that each of the materials is a low-viscosity liquid, they can be maid into a coating solution by mixing various necessary materials therein, however, to perform excellent atomization, a sufficient flowability is required for the coating solution when using a spray-coating method. Therefore, it is preferable that the coating solution be diluted with an organic solvent to adjust the viscosity. The organic solvent used here is as described above, and it will not be described in detail, however, according to the present inventors, the boiling point of the organic solvent is preferably 90° C. or less at one atmospheric pressure, more preferably 60° C. to 90° C., and still more preferably 60° C. to 80° C. Each of these organic solvents may be used alone or in combination with two or more. The dilution ratio of the coating solution of the organic solvent is determined depending on properties of the component of the coating solution.

In the present invention, the coating solution is applied over a surface of a photosensitive layer, and then the surface layer is cured by applying an external energy thereto. For the external energy used at that time, light energy is mainly used, however, may be used in combination with heat energy.

For heat energy, gases such as air, and nitrogen gas; vapor; or various heat media, infrared rays, and electromagnetic rays can be used, and the surface layer is heated from the coating layer side or the substrate side to cure the surface layer. The heating temperature is preferably 100° C. to 170° C. When the heating temperature is less than 100° C., the productivity may be degraded due to the slow reaction rate, and it may cause residues of unreacted materials in the film. In contrast, when the surface layer is heated at a temperature higher than 170° C., it is unfavorable because the film is largely shrunk by crosslinking reaction, the surface layer may have irregularities and/or cracks, and the surface layer may be exfoliated from the immediately-adjacent layer at the interface. When a resin which would have a large amount of shrinkage by crosslinking is used, a method is effective in which the surface layer is preliminarily crosslinked at a low-temperature less than 100° C. and thereafter completely crosslinked at a high temperature higher than 100° C.

For light energy, light sources typified by ultrahigh pressure mercury lamp, high pressure mercury lamp, low-pressure mercury lamp, carbon arc, and xenon arc metal halide lamp may be utilized, however, it is preferable to select a light source in consideration of absorption of the titanocene derivative described in the present invention. For the emission wavelength of the light source to be used, there is no problem in using typically used ultraviolet ray regions because the titanocene derivative absorbs ultraviolet rays, however, it is more preferred to consider the absorption of the radical polymerizable monomer having an electric charge transportable structure, as stated above. Specifically, by using a light source having a maximum emission wavelength of 400 nm or more, irradiation of light is efficiently absorbed to titanocene because of low-light absorption rate of the radical polymerizable monomer having an electric charge transportable structure. Thus, it is easily obtain a cured film which is uniformly formed from the layer surface through to the inside of the layer.

For the emission illuminance of the light source to be used, the surface layer is preferably exposed at an illuminance of 50 mW/cm² to 2,000 mW/cm² on the basis typically of a wavelength of 356 nm. When the illuminance measurement is enabled at wavelengths close to the maximum emission wavelength, it is more preferred to expose the surface layer within the above-noted illuminance range. When the illuminance is low, it takes a long time to cure the surface layer, and it is unfavorable from the perspective of productivity. In contrast, when the illuminance is high, the surface layer is easily shrunk resulting from curing, and may have irregularities and/or cracks, and may be exfoliated from the immediately-adjacent layer at the interface.

When the surface layer is irradiated with a UV ray, the temperature of the surface layer of the photoconductor is raised by influence of heat ray emitted from the light source. When the temperature of the photoconductor surface is excessively raised, it is unfavorable because it causes curing inhibition, and electric properties as an electrophotographic photoconductor are degraded because the surface layer is easily shrunk resulting from curing, and low-molecular components contained in the immediately-adjacent layer are transferred to the surface layer. Therefore, the temperature of the photoconductor surface at the time of irradiation of a UV ray is set typically at 100° C. or less, preferably set at 80° C. or less. For the cooling method of the photoconductor, it can be cooled by encapsulating a cooling-auxiliary agent inside the photoconductor or introducing a gas or a liquid into the photoconductor.

The thickness of the surface layer is preferably 1 μm to 20 μm and more preferably 3 μm to 15 μm from the perspective of protection of the photoconductor. When the surface layer is thin, not only the photoconductor cannot be protected from mechanical wear of the photoconductor induced by members having contact with the photoconductor and proximate electric discharge from a charger but also the photoconductor surface is hardly leveled at the time of film formation, and thus the film surface may have irregularities. In contrast, when the surface layer is thick, it is unfavorable because the overall photoconductor layer is thickened, and reproductivity of image is degraded by electric charge diffusion.

—Adhesive Layer—

With a view to preventing interlayer exfoliation resulting from adhesion failure induced between the surface layer and the photosensitive layer, an adhesive layer may be disposed between the surface layer and the photosensitive layer in accordance with the necessity.

For the adhesive layer, the radical polymerizable monomer having no electric charge transportable structure may be used, or a non-crosslinkable high-molecular compound may be used. The non-crosslinkable high molecular compound is not particularly limited and may be suitably selected in accordance with the intended use. Examples thereof include polyamides, polyurethanes, epoxy resins, polyketones, polycarbonates, silicone resins, acrylic resins, polyvinylbutyrals, polyvinylformals, polyvinylketones, polystyrenes, poly-N-vinylcarbazoles, polyacrylamides, polyvinylbenzals, polyesters, phenoxy resins, vinylchloride-vinylacetate copolymers, polyvinylacetates, polyphenylene oxides, polyvinylpyridines, cellulose resins, caseins, polyvinyl alcohols, and polyvinyl pyrolidones. When any one of the radical polymerizable monomer and the non-crosslinkable high-molecular compound is used, these materials may be used alone or may be used as a mixture of two or more. Alternatively, the radical polymerizable monomer may be used in combination with the non-crosslinkable high-molecular compound provided that sufficient adhesiveness can be obtained. As a matter of course, electric charge transportable materials described in the present invention may be used. For the purpose of improving the adhesiveness between the surface layer and the photosensitive layer, additives may be used in an appropriate amount.

The adhesive layer can be formed by applying a coating solution in which a compound prepared so as to have a prescribed composition is dissolved or dispersed in a solvent such as tetrahydrofuran, dioxane, dichloroethane, and cyclohexane to the photosensitive layer by immersion coating method, spray-coating method, bead-coating method, or ring-coating method. The thickness of the adhesive layer is preferably 0.1 μm to 5 μm, and more preferably 0.1 μm to 3 μm.

<Photosensitive Layer>

The photosensitive layer may take, as described above, a function-separated laminate structure or may take a unilaminar structure. When a photosensitive layer is formed in a laminate structure, the photosensitive layer is typically provided with an electric charge generating layer and an electric charge transporting layer. When a photosensitive layer is formed in a unilaminar structure, the photosensitive layer is a layer having electric charge generating function as well as electric charge transporting function. Hereinafter, a photosensitive layer having a laminate structure and a photosensitive layer having a unilaminar structure will be described, respectively.

—Electric Charge Generating Layer—

The electric charge generating layer is a layer having an electric charge generating material having electric charge generating function as the main component, and a binder resin can be used in combination with the electric charge generating material. For the electric charge generating material, inorganic materials and organic materials can be used.

Examples of the inorganic materials include crystal seleniums, amorphous-seleniums, selenium-tellurium-halogens, selenium-arsenic compounds, and amorphous-silicons. For amorphous-silicons, those in which a dangling-bond is terminated with hydrogen atom or halogen atom, and those in which boron atom or phosphorous atom or the like is doped are preferably used.

For the organic materials, those known in the art can be used. Examples thereof include phthalocyanine pigments such as metal phthalocyanine, and metal-free phthalocyanine; azulenium salt pigments; squaric acid methine pigments; azo pigments having a carbazole skeleton; azo pigments having a triarylamine skeleton; azo pigments having a diphenylamine skeleton; azo pigments having a dibenzothiophene skeleton; azo pigments having a fluorenone skeleton; azo pigments having an oxadiazole skeleton; azo pigments having a bis-stilbene skeleton; azo pigments having a distilyloxadiazole skeleton; azo pigments having a distiylylcarbazole skeleton; perylene pigments, anthraquinone or polycyclic quinone pigments; quinoneimine pigments; diphenylmethane and triphenylmethan pigments; benzoquinone and naphthoquinone pigments; cyanine and azomethine pigments, indigoid pigments, and bis-benzimidazole pigments. These electric charge generating materials may be used alone or may be used as a mixture of two or more.

Examples of the binder resin used for the electric charge generating layer in accordance with the necessity include polyamides, polyurethanes, epoxy resins, polyketones, polycarbonates, silicone resins, acrylic resins, polyvinylbutyrals, polyvinylformals, polyvinylketones, polystyrenes, poly-N-vinylcarbazoles, polyacrylamides, polyvinylbenzals, polyesters, phenoxy resins, vinylchloride-vinylacetate copolymers, polyvinyl acetates, polyphenylene oxides, polyvinyl pyridines, cellulose resins, caseins, polyvinyl alcohols, polyvinyl pyrolidones. These binder resins may be used alone or may be used as a mixture of two or more.

The content of the binder resin is preferably zero parts by mass to 500 parts by mass, and more preferably 10 parts by mass to 300 parts by mass relative to 100 parts by mass of the electric charge generating material. The addition of the binder resin may be before or after the dispersion of the materials of the electric charge generating layer.

The method for forming the electric charge generating layer is broadly divided into vacuum thin-film forming method and casting method using a dispersed solution. For the former method i.e. vacuum thin-film forming method, vacuum evaporation method, glow discharge decomposition, ion-plating method, sputtering method, reactive sputtering method, or CVD method is used, and the electric charge generating layer can be excellently formed by using the above-mentioned inorganic material(s) or organic material(s). To form an electric charge generating layer by the latter method i.e. casting method, the above-mentioned inorganic or organic electric charge generating material is, when necessary, dispersed using a solvent of tetrahydrofuran, dioxane, dioxsolan, toluene, dichloromethane, monochlorobenzene, dichloroethane, cyclohexanone, cyclopentanone, anisole, xylene, methylethylketone, acetone, ethylacetate, butylacetate, etc. along with the binder resin by means of a ball mill, an attritor, a sand mill, a bead mill, or the like, the dispersion liquid is diluted appropriately, and the diluted dispersion liquid is applied over the substrate surface to thereby form an electric charge generating layer. In accordance with the necessity, leveling agents such as dimethyl silicone oil, and methylphenyl silicone oil can be added to the materials of the electric charge generating layer.

The application of the diluted dispersion liquid can be performed by immersion coating method, spray coating method, bead coating method, or ring coating method.

The thickness of the electric charge generating layer is preferably 0.01 μm to 5 μm, and still more preferably 0.05 μm to 2 μm.

—Electric Charge Transporting Layer—

The electric charge transporting layer is a layer which has electric charge transporting function and contains an electric charge transportable material and a binder resin as the main components.

For the electric charge transportable materials, there are hole-transporting materials and electron-transporting materials.

Examples of the electron-transporting materials include electron-accepting materials such as chloranil, bromoanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitorothioxanthone, 2,6,8-trinitoro-4H-indeno[1,2-b]thiophene-4-on, 1,3,7-trinitorodibenzothiophene-5,5-dioxide, and diphenoquinone derivatives. Each of these electron-transporting materials may be used alone or may be used as a mixture of two or more.

Examples of the hole-transporting materials include poly-N-vinylcarbazole or derivatives thereof, poly-γ-carbazolylethylglutamate or derivatives thereof, pyrene-formaldehyde condensates or derivatives thereof, polyvinylpyrene, polyvinylphenanthrene, polysilane, oxazole derivatives, imidazole derivatives, monoarylamine derivatives, diarylamine derivatives, triarylamine derivatives, stilbene derivatives, α-phenylstilbene derivatives, benzidine derivatives, diarylmethan derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, enamine derivatives, and other known hole-transporting materials. These hole-transporting materials may be used alone or may be used as a mixture of two or more.

Examples of the binder resin include thermoplastic or thermosetting resins such as polystyrenes, styrene-acrylonitrile copolymers, styrene-butadiene copolymers, styrene-maleic acid anhydride copolymers, polyesters, polyvinylchlorides, vinylchloride-vinylacetate copolymers, polyvinyl acetates, polyvinylidene chlorides, polyarylate resins, phenoxy resins, polycarbonates, acetylcellulose resins, ethylcellulose resins, polyvinylbutyrals, polyvinylformals, polyvinyltoluenes, poly-N-vinylcarbazoles, acrylic resins, silicone resins, epoxy resins, melamine resins, urethane resins, phenol resins, and alkyd resins. In addition, as the binder resin, it is also possible to use a high-molecular electric charge transporting materials having electric charge transporting function, for example, polycarbonate having an arylamine skeleton, a benzidine skeleton, a hydrazone skeleton, a carbazole skeleton, a stilbene skeleton, a pyrazoline skeleton, or the like; high-molecular materials such as polyester, polyurethane, polyether, polysiloxane, and acrylic resin; and high-molecular materials having a polysilane skeleton.

The content of the electric charge transporting material is typically 20 parts by mass to 300 parts by mass, preferably 40 parts by mass to 150 parts by mass relative to 100 parts by mass of the binder resin. However, when a high-molecular electric charge transporting material is used, the material may be used alone or may be used in combination with a binder resin.

As a solvent used here, tetrahydrofuran, dioxane, toluene, dichloromethane, monochlorobenzene, dichloroethane, cyclohexanone, methylethylketone, acetone, etc. can be used. These solvents may be used alone or may be a mixture of two or more.

In addition, a plasticizer and a leveling agent can be used. For a plasticizer used for the electric charge transporting layer, those used as plasticizers for typical resins such as dibutylphthalate, and dioctylphthalate can be directly used, and the usage of the plasticizer is typically zero parts by mass to 30 parts by mass relative to 100 parts by mass of the binder resin. For a leveling agent usable for the electric charge transporting layer, it is possible to use silicone oils such as dimethylsilicone oil, methylphenyl silicone oil, polymers having a perfluoroalkyl group at the side chains thereof or oligomers, and the usage of the leveling agent is typically around zero parts by mass to 1 part by mass relative to 100 parts by mass of the binder resin.

The thickness of the electric charge transporting layer is preferably 30 μm or less and more preferably 25 μm or less in terms of resolution and responsiveness. The minimum thickness of the electric charge transporting layer differs depending on the system to be used, particularly depending on charge potential, however, it is preferably 5 μm or more.

<In Case of Unilaminar Photosensitive Layer>

The unilaminar photosensitive layer is a layer having electric charge generating function as well as electric charge transporting function. The photosensitive layer can be formed by dissolving or dispersing the electric charge generating material, the electric charge transporting material, and the binder resin in a proper solvent, applying the solution over a surface of the substrate, and drying the substrate surface. A plasticizer, a leveling agent, an antioxidizing agent and the like can be added in accordance with the necessity. For the binder resin, the binder resins mentioned above for the electric charge transporting layer can be used. Besides, the binder resins mentioned above for the electric charge generating layer may be mixed with therewith for use. As a matter of course, the above-mentioned high-molecular electric charge transporting materials can also be preferably used. The amount of the electric charge generating material relative to 100 parts by mass of the binder resin is preferably 5 parts by mass to 40 parts by mass, and the amount of the electric charge transporting material relative to 100 parts by mass of the binder resin is preferably zero parts by mass to 190 parts by mass, and more preferably 50 parts by mass to 150 parts by mass. The photosensitive layer can be formed by applying a coating solution in which an electric charge generating material, a binder resin, and an electric charge transporting material are dispersed in a solvent such as tetrahydrofuran, dioxane, dichloroethane, and cyclohexane using a dispersing unit, to a surface of the substrate by immersion coating method, spray-coating method, bead-coating method, or ring-coating method. The thickness of the photosensitive layer is typically around 5 μm to 25 μm.

—Undercoat Layer—

In the photoconductor of the present invention, an undercoat layer can be disposed between the conductive substrate and the photosensitive layer. Typically, the undercoat layer contains a resin as the main component, however, in consideration that a solvent of the photosensitive layer is applied on the resin, the resin preferably has high solvent resistance to typical organic solvents. Examples of such a resin include water-soluble resins such as polyvinyl alcohol, casein, sodium polyacrylate; alcohol-soluble resins such as copolymerized nylon, methoxymethylated nylon; and curable resins capable forming three-dimensional network such as polyurethanes, melamine resins, phenol resins, alkyd-melamine resins, epoxy resins. In addition, to the undercoat layer, fine powder pigments of metal oxides typified by titanium oxide, silica, alumina, zirconium oxide, tin oxide, and indium oxide may be added for prevention of moiré, reduction of residual potential, and the like.

The undercoat layer can be formed using an appropriate solvent and coating method, like the above-mentioned photosensitive layer. Further, for the undercoat layer in the present invention, a silane coupling agent, a titanium coupling agent, a chrome coupling agent, etc. can also be used. Besides, for the undercoat layer in the present invention, the one formed by anodizing Al₂O₃, and the one formed with organic materials such as polyparaxylylene (parylene) or inorganic materials such as SiO₂, SnO₂, TiO₂, ITO, and CeO₂ by vacuum thin-film forming method can be preferably used. Besides, those known in the art can also be used. The thickness of the undercoat layer is typically 0 μm to 5 μm.

—Substrate—

For the substrate, it is possible to use the one capable of exhibiting conductivity of volume resistivity of 10¹⁰Ω·cm or less, for example, those in which film-shaped or cylindrical plastic or paper is coated with a metal oxide such as aluminum, nickel, chrome, nichrome, copper, gold, silver, and platinum, or a metal oxide such as tin oxide, indium oxide by vapor deposition or sputtering; or a tube which is prepared by making a plate made of aluminum, aluminum alloy, nickel, stainless, etc. is made into a tube by extrusion method, drawing method or the like, and subjecting the tube to surface treatments such as cutting, superfinishing, and grinding. In addition, endless nickel belts, and endless stainless belts disclosed in Japanese Patent Application Laid Open (JP-A) No. 52-36016 can also be used as the conductive substrate.

Besides, the one that is prepared by dispersing a conductive powder in an appropriate binder resin, and applying the dispersion liquid over a surface of the substrate can also be used as the conductive substrate in the present invention. Examples of the conductive power include carbon black; acetylene black; metal powders such as aluminum, nickel, iron, nichrome, copper, zinc, and silver; or metal oxide powers such as conductive tin oxide, and ITO. Examples of the binder resin used along with the conductive power include thermoplastic or heat-crosslinkable resins or photo-crosslinkable resins such as polystyrenes, styrene-acrylonitrile copolymers, styrene-butadiene copolymers, styrene-maleic acid anhydride copolymers, polyesters, polyvinyl chlorides, vinyl-chloride-vinylacetate copolymers, polyvinylacetates, polyvinylidene chlorides, polyarylate resins, phenoxy resins, polycarbonates, acetylcellulose resins, ethylcellulose resins, polyvinyl butyrals, polyvinylformals, polyvinyltoluene, poly-N-vinylcarbazoles, acrylic resins, silicone resins, epoxy resins, melamine resins, urethane resins, phenol resins, and alkyd resins. Such a conductive layer can be formed by dispersing these conductive powers and a binder resin in an appropriate solvent such as tetrahydrofuran, dichloromethane, methylethylketone, or toluene, and applying the dispersion liquid over a surface of the substrate.

Further, it is also possible to preferably use the one provided with a conductive layer on an appropriate tubular base as the conductive substrate in the present invention, the conductive layer being made of a heat-shrinkable tube in which the conductive powder is contained in a raw material such as polyvinyl chloride, polypropylene, polyester, polystyrene, polyvinylidene chloride, polyethylene, chlorinated rubber, and polytetraphloroethylene fluorine resin.

Further, in the present invention, for the purpose of improving environment resistance, in particular, for the purpose of preventing degradation of sensitivity, and increase in residual potential, an antioxidizing agent can be added to various layers such as a surface layer, a photosensitive layer, an electric charge generating layer, an electric charge transporting layer, an undercoat layer, an intermediate layer, and a light shielding layer.

Examples of the antioxidizing agent include phenol compounds, paraphenylenediamines, hydroquinones, organic sulfur compounds, and organic phosphorous compounds. Each of these antioxidizing agents may be used alone or in combination with two or more.

Examples of the phenol compound include 2,6-di-t-butyl-p-cresol, butylated hydroxyanisol, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, and tocopherols.

Examples of the paraphenylenediamines include N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

Examples of the hydroquinones include 2,5-di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

Examples of the organic sulfur compounds include dilauryl-3,3′-thiodipropyonate, distearyl-3,3′-thiodipropyonate, and ditetradecyl-3,3′-thiodipropyonate.

Examples of the organic phosphorous compounds include triphenylphosphine, tri(nonylphenyl)phosphine, tri(dinonylphenyl)phosphine, tricresylphosphine, and tri(2,4-dibutylphenoxy)phosphine.

These compounds are known as antioxidizing agents for rubbers, plastics, and oils, and commercial products thereof are readily available.

The added amount of the antioxidizing agent is not particularly limited and may be suitably adjusted in accordance with the intended use, however, it is preferably 0.01% by mass to 10% by mass relative to the total mass of the layer to which the antioxidizing agent is added.

<Example of Synthesis of Radical Polymerizable Monomer Having Electric Charge Transportable Structure>

The compound having an electric charge transportable structure in the present invention can be synthesized by a method described, for example, in Japanese Patent No. 3164426. Example of the synthesizing method will be described below.

—(1) Synthesis of Hydroxy Group-Substituted Triarylamine Compound (the Following Structural Formula B)—

In a vessel, 240 mL of sulfolane was added to 113.85 g (0.3 mole) of a methoxy group-substituted triarylamine compound (the following Structural Formula (1)), and 138 g (0.92 mole) of sodium iodide, and the solution was heated to 60° C. under nitrogen gas stream. Then, 99 g (0.91 mole) of trimethylchlorosilane was dropped into the solution in one hour, and the solution was stirred for 4.5 hours at a temperature of around 60° C., and the reaction was terminated. To the reaction liquid, approximately 1.5 L of toluene was added, and the reaction liquid was cooled to the room temperature, and then repetitively washed with water and a sodium carbonate aqueous solution. Thereafter, the solvent was removed from the toluene solution, and the solution was purified by column chromatography (absorption medium: silica gel; developing solvent:toluene:ethyl acetate=20:1). Cyclohexane was added to the obtained cream-colored oil to precipitate crystal. In this way, 88.1 g (yield=80.4%) of white-color crystal represented by the following Structural Formula (2) was obtained.

Melting point: 64.0° C. to 66.0° C.

Element analytical value: (%)

TABLE 1

| | C | H | N |
|---|---|---|---|
| Measured value | 85.06 | 6.41 | 3.73 |
| Calculated value | 85.44 | 6.34 | 3.83 |

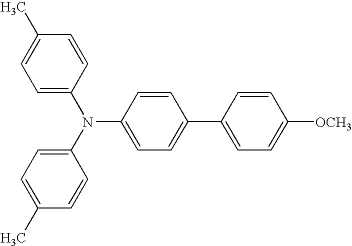

Structural Formula (1)

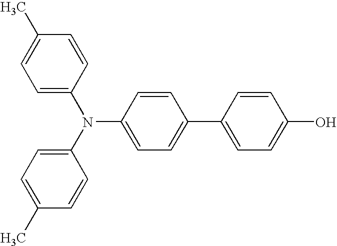

Structural Formula (2)

—(2) Synthesis of Triarylamine Group-Substituted Acrylate Compound—

In a vessel, 82.9 g (0.227 mole) of the hydroxy group-substituted triarylamine compound obtained in the (1) (Structural Formula B) was dissolved in 400 mL of tetrahydrofuran, and a sodium hydroxide solution (NaOH: 12.4 g, water: 100 mL) was dropped into the dissolved solution under nitrogen gas stream. The solution was cooled to 5° C., and 25.2 g (0.272 mole) of acrylic acid chloride was dropped in the reaction vessel in 40 minutes. Thereafter, the solution was stirred for 3 hours at a temperature of 5° C., and the reaction was terminated. The reaction liquid was poured to water to obtain extract thereof using toluene. The extract was repetitively washed with a sodium hydrogen carbonate aqueous solution and water. Thereafter, the solvent was removed from the toluene solution, and the solution was purified by column chromatography (absorption medium: silica gel; developing solvent:toluene). Then, n-hexane was added to the obtained colorless oil to precipitate crystal. In this way, 80.73 g (yield=84.8%) of white-color crystal of Compound Example No. 1 was obtained.

Melting point: 117.5° C. to 119.0° C.

Element analytical value: (%)

TABLE 2

| | C | H | N |
|---|---|---|---|
| Measured value | 83.13 | 6.01 | 3.16 |
| Calculated value | 83.02 | 6.00 | 3.33 |

—(3) Synthesis of Acrylic Acid Ester Compound—
(Preparation of 2-hydroxybenzyl diethylphosphonate)

To a reaction vessel equipped with a stirrer, a thermometer, and a dropping funnel, 38.4 g of 2-hydroxybenzyl alcohol (available from Tokyo Kasei Co., Ltd.), and 80 mL of o-xylene were poured, and 62.8 g of trimethyl phosphite (available from Tokyo Kasei Co., Ltd.) was slowly dropped into the solution at a temperature of 80° C. under nitrogen gas stream, and the reaction was further performed at the same temperature for 1 hour. Thereafter, generated ethanol, solvent of o-xylene, and unreacted trimethyl phosphite were removed from the solution by reduced-pressure distillation to thereby obtain 66 g of 2-hydroxybenzyl diethylphosphonate (boiling point: 120.0° C./1.5 mmHg) (yield: 90%).

(Preparation of 2-hydroxy-4′-(N,N-bis(4-methylphenyl)amino) stilbene)

To a reaction vessel equipped with a stirrer, a thermometer, and a dropping funnel, 14.8 g of potassium-tert-buthoxide, and 50 mL of tetrahydrofuran were poured, and then a solution of which 9.90 g of 2-hydroxybenzyl diethylphosphonate and 5.44 g of 4-(N,N-bis(4-methylphenyl)amino)benzaldehyde were dissolved in tetrahydrofuran, was slowly dropped in the reaction vessel at the room temperature under nitrogen gas stream, and then the reaction was performed at the same temperature for 2 hours. Thereafter, water was added to the solution while water-cooling the solution, and then, different two types of defined hydrochloric acid aqueous solutions were added to the solution, and the solution was acidified. Then, tetrahydrofuran was removed from the acidified solution using an evaporator to extract a coarse product using toluene. The toluene phase was washed using water, a sodium acid carbonate aqueous solution, and saturated saline in this order, and magnesium sulfate was added thereto for dehydration. After filtration, toluene was removed to obtain an oil-like coarse product. The coarse product was further purified by column chromatography with silica gel and then crystallized in hexane to thereby obtain 5.09 g of 2-hydroxy-4′-(N,N-bis(4-methylphenyl)amino)stilbene. (yield: 72%; melting point: 136.0° C. to 138.0° C.).

(Preparation of 4′-(N,N-bis(4-methylphenyl)amino) stilbene-2-ylacrylate)

To a reaction vessel equipped with a stirrer, a thermometer, and a dropping funnel, 14.9 g of 2-hydroxy-4′-(N,N-bis(4-methylphenyl)amino)stilbene, 100 mL of tetrahydrofuran, and 21.5 g of a 12% concentration sodium hydroxide aqueous solution were poured, and 5.17 g of acrylic acid chloride was dropped in the solution at a temperature of 5° C. over 30 minutes under nitrogen gas stream. Thereafter, the reaction was performed at the same temperature for 3 hours. The reaction liquid was poured into water, and then an extract was obtained using toluene. The extract was condensed, and the condensate was purified by column chromatography with silica gel. The obtained coarse product was re-crystallized using ethanol to thereby obtain 13.5 of yellow needle-like crystal of 4′-(N,N-bis(4-methylphenyl)amino) stilbene-2-ylacrylate (Compound Example No. 2) (yield: 79.8%; melting point 104.1° C. to 105.2° C.).

Table 3 shows the analyzed result of the element.

Element analytical value (%)

TABLE 3

| | C | H | N |
|---|---|---|---|
| Measured value | 83.46 | 6.06 | 3.18 |
| Calculated value | 83.57 | 6.11 | 3.14 |

As described above, by reacting 2-hydroxybenzyl phosphorous acid ester derivative with various amino-substituted benzaldehyde derivatives, it is possible to synthesize a number of 2-hydroxystilbene derivatives, and by acrylating or methacrylating the 2-hydroxystilbene derivatives, it is possible to synthesize various acrylic acid ester compounds.

(Image Forming Apparatus and Image Forming Method)

An image forming apparatus of the present invention is provided with at least an electrophotographic photoconductor, a latent electrostatic image forming unit, a developing unit, a transferring unit, and a fixing unit, and further provided with other units suitably selected in accordance with the necessity, for example, a cleaning unit, a charge eliminating unit, a recycling unit, and a controlling unit.

The image forming method of the present invention includes at least forming a latent electrostatic image, developing, transferring, fixing, and further includes other steps suitably selected in accordance with the necessity, for example, cleaning, charge-eliminating, recycling, and controlling.

The image forming method of the present invention can be suitably performed by using an image forming apparatus of the present invention, the forming a latent electrostatic image can be performed by the latent electrostatic image forming unit, the developing can be performed by the developing unit, the transferring can be performed by the transferring unit, the fixing can be performed by the fixing unit, and other steps stated above can be performed by other units.

—Latent Electrostatic Image Forming and Latent Electrostatic Image Forming Unit—

The latent electrostatic image forming is a step in which a latent electrostatic image is formed on an electrophotographic photoconductor.

For the electrophotographic photoconductor, the electrophotographic photoconductor is used.

In the latent electrostatic image forming, for example, the surface of the electrophotographic photoconductor is uniformly charged, and the surface thereof can be exposed imagewisely by means of the latent electrostatic forming unit. The latent electrostatic image forming unit is provided with at least a charger configured to uniformly charge the surface of the electrophotographic photoconductor and an exposer configured to expose the charged surface of the electrophotographic photoconductor.

The charging can be performed by applying a voltage to the surface of the electrophotographic photoconductor through the use of, for example, the charger.

The charger is not particularly limited, may be suitably selected in accordance with the intended use, and examples thereof include contact chargers known in the art, for example, which are equipped with a conductive or semi-conductive roll, a brush, a film, and a rubber blade, and non-contact chargers utilizing corona discharge such as corotoron and scorotoron.

The exposing can be performed by exposing the surface of the electrophotographic photoconductor imagewisely through the use of, for example, the exposer.

The exposer is not particularly limited as long as the surface of the electrophotographic photoconductor which has been charged by the charger can be exposed imagewisely, may be suitably selected in accordance with the intended use, and examples thereof include various types of exposers such as reproducing optical systems, rod lens array systems, laser optical systems, and liquid crystal shutter optical systems.

In the present invention, the back light method may be employed in which exposing is performed imagewisely from the back side of the electrophotographic photoconductor.

The image exposing can be performed, when an image forming apparatus is used as a copier and/or a printer, by irradiating reflected light or transmitted light from an original document sheet or by reading the original document using a sensor, converting the information to signals, and scanning the information by a laser beam in accordance with the signals, driving of LED arrays, or drying of liquid crystal shutter arrays to apply a light to the electrophotographic photoconductor.

—Developing and Developing Unit—

The developing is a step in which the latent electrostatic image is developed using a toner and/or a developer to form a visible image.

The visible image can be formed by developing the latent electrostatic image using, for example, a toner and/or a developer, by means of the developing unit.

The developing unit is not particularly limited as long as latent electrostatic images can be developed using a toner and a developer, and may be suitably selected from those in the art. Preferred examples thereof include the one having at least an image developing apparatus which houses a toner and/or a developer therein and enables supplying the toner and/or the developer in contact or in non-contact therewith.

In the image developing apparatus, typically dry-developing process is employed. The image developing apparatus may be an image developing apparatus for monochrome color or multi-colors. Preferred examples thereof include the one having a stirrer by which a toner and/or a developer are rubbed and stirred to be charged, and a rotatable magnet roller.

In the image developing apparatus, for example, a toner and/or a developer are mixed and stirred, the toner is charged by frictional force at that time to be held in the state where the toner is standing on the surface of the rotating magnet roller to thereby form a magnetic brush. Since the magnet roller is arranged near the electrophotographic photoconductor, part of the toner constituting the magnetic brush formed on the surface of the magnet roller moves to the surface of the electrophotographic photoconductor by electric attraction force. As a result, the latent electrostatic image is developed with the toner to form a visible image according to the toner on the surface of the electrophotographic photoconductor.

The developer to be housed in the image developing apparatus is a developer which contains a toner, however, the developer may be a one-component developer or a two-component developer. For the toner, it is possible to use usually used toners.

—Transferring and Transferring Unit—

The transferring is a step in which the visible image is transferred onto a recording medium, and it is preferably an aspect in which an intermediate transfer member is used, the visible image is primarily transferred to the intermediate transfer member and then the visible image is secondarily transferred to the recording medium. More preferably, it is an aspect of the transferring in which two or more colors are used, preferably a full-color toner is used, and the aspect includes a primary transferring in which the visible image is transferred onto an intermediate transfer member to form a composite transfer image and a secondary transferring in which the composite transfer image is transferred onto a recording medium.

The transferring can be performed by charging the visible image using a transfer-charger to charge the surface of the electrophotographic photoconductor by means of the transferring unit.

For the transferring unit, it is preferably an aspect which includes a primary transferring unit configured to transfer the visible image onto an intermediate transfer member to form to a composite transfer image, and a secondary transferring unit configured to transfer the composite transfer image onto a recording medium.

The intermediate transfer member is not particularly limited, may be suitably selected from those in the art in accordance with the intended use, and preferred examples thereof include transferring belts.

The transferring unit, i.e. the primary transferring unit and the secondary transferring unit, preferably have at least a transferring unit configured to separate the visible image formed on the electrophotographic photoconductor to the recording medium to charge the visible image. For the transferring unit, there may be one transferring unit or two or more transferring units.

Examples of the transferring unit include corona transferring units by means of corona discharge, transferring belts, transfer rollers, pressure transfer rollers, and adhesion transferring units.

The recording medium is typically standard paper, however, it is not particularly limited, provided that unfixed image after developing can be transferred thereto, may be suitably selected in accordance with the intended use, and media such as PET base for OHP can also be used.

—Fixing and Fixing Unit—

The fixing is a step in which the visible image transferred onto a recording medium is fixed using an image fixing apparatus, and the fixing may be performed every time each individual color toners is transferred onto the recording medium or at a time in the condition where each individual color toners has been superimposed.

The image fixing apparatus is not particularly limited, may be suitably selected in accordance with the intended use, and heating and pressurizing units known in the art are preferably used. Examples of the heating and pressurizing units include a combination of a heat roller and a pressure roller, and a combination of a heat roller, a pressure roller, and an endless belt.

The heating temperature in the heating and pressurizing unit is preferably 80° C. to 200° C.

In the present invention, for example, optical fixing units known in the art may be used along with or instead of the fixing and the fixing unit.

—Cleaning and Cleaning Unit—

The cleaning is a step in which a residual toner on the electrophotographic photoconductor is removed using a cleaning unit.

Examples of the cleaning unit include cleaning blades, magnetic brush cleaners, electrostatic brush cleaners, magnetic roller cleaners, blade cleaners, brush cleaners, and web cleaners.

The charge-eliminating is a step in which electricity is eliminated by applying charge-eliminating bias to the electrophotographic photoconductor, and the charge-eliminating can be suitably performed by means of a charge-eliminating unit.

The charge-eliminating unit is not particularly limited and may be required only to have the ability for applying charge-eliminating bias to the electrophotographic photoconductor, and may be suitably selected from charge-eliminating units known in the art. For example, a charge-eliminating lamp is preferably used.

The recycling is a step in which the toner eliminated in the cleaning is recycled, and the recycling can be suitably performed by means of a recycling unit.

The recycling unit is not particularly limited as long as it enables controlling actions of the individual units, and may be suitably selected in accordance with the intended use. Examples thereof include instruments such a sequencers, and computers.

The controlling is a step in which individual steps described above are controlled, and the controlling can be suitably performed by means of a controlling unit.

The controlling unit is not particularly limited, provided that it can control movements of the individual units, and may be suitably selected in accordance with the intended use. Examples thereof include equipments such as sequencers and computers.

Here, the image forming method and the image forming apparatus of the present invention will be described in detail, referring to drawings.

The image forming apparatus utilizes a photoconductor having the crosslinked surface layer and enables a series of processes, for example, at least charging of the photoconductor, exposing of an image with a light, and developing of the image, transferring of a toner image onto a transferring sheet, fixing the toner image, and cleaning of the surface of the photoconductor.

In some situations, in a latent electrostatic image is directly transferred to a transferring member to develop the image, the above-noted processes relating to a photoconductor are not necessarily required.

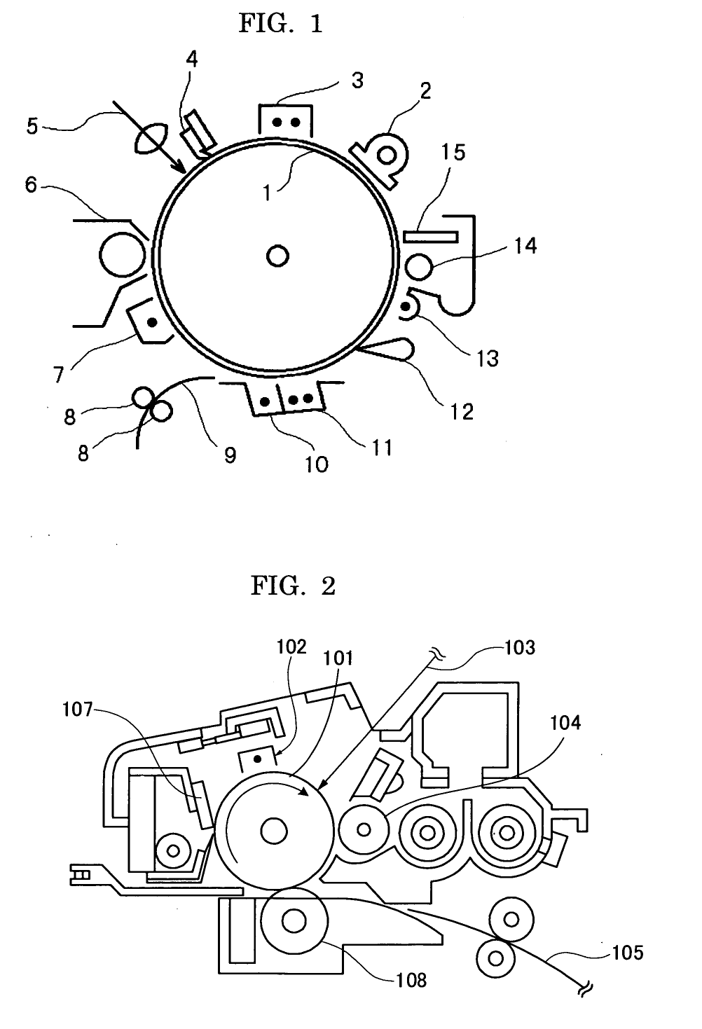

FIG. 1 is a view schematically showing one example of the image forming apparatus. The image forming apparatus uses three charges as a unit for averagely charging a photoconductor. For the charging unit, it is possible to use various units such as corotoron device, scorotoron device, solid discharging element, needle electrode device, roller charging device, and conductive brush device.

Next, an image exposing unit 5 is used for forming a latent electrostatic image on a uniformly charged photoconductor 1. For the light source, it is possible to use various light-emitting units such as fluorescent light, tungsten lamp, halogen lamp, mercury lamp, sodium lamp, light-emitting diode (LED), semiconductor laser (LD), and electroluminescence (EL). To irradiate a photoconductor with only a light having a desired wavelength range, it is possible to use various filters such as sharp-cut filters, band pass filters, near-infrared cut filters, dichroic filters, interference filters, and color conversion filters.

Next, a developing unit 6 is used for making the latent electrostatic image formed on the photoconductor 1 into a visible image. For the developing method, there are one-component developing method and two-component development method using a dry toner, and wet-developing method using a wet toner. When a photoconductor is positively or negatively charged to expose an image, a latent electrostatic image can be formed on the photoconductor.

When the latent electrostatic image is developed using a negative polar toner (volt-detecting fine particles), a positive image can be formed on the photoconductor surface. When the latent electrostatic image is developed using a positive polar toner, a negative image can 1,5 be formed on the photoconductor surface.

Next, a transferring charger 10 is used for transferring a toner image which has been visualized on the photoconductor to a transferring member 9. To more favorably performing the transferring, pre-transfer charger 7 may be used. For these transferring units, it is possible to utilize electrostatic transferring method using a transfer charger and a bias roller; automatic transferring method such as adhesion transferring method, and pressure transferring method; and magnetic transferring method. In the electrostatic transferring method, the charging unit can be utilized.

Next, for units for separating the transfer member 9 from the photoconductor 1, a separator charger 11, and a separation pawl 12 are used. For the other separation methods, electrostatic absorption inducing separation, side edge belt separation, front edge grip conveyance, curvature separation, etc. can be utilized.

Next, a fur brush 14, and a cleaning blade 15 are used for cleaning a toner remaining after transferring on the photoconductor 1. A pre-cleaning charger 13 may be used for efficiently perform cleaning. For the other cleaning methods, there are web methods, and magnet brush methods, and each of these methods may be employed alone or in combination with two or more together.

Next, a charge eliminating unit is used for removing a latent image on the photoconductor in accordance with necessity. For the charge eliminating unit, a charge eliminating lamp 2, and charge eliminator are used, and the exposure light source and the charging unit can be utilized.

Besides, for processes that are not arranged close to the photoconductor, i.e., reading of original document, sheet-feeding, fixing, paper-ejection, and the like, those known in the art can be used.

The present invention provides an image forming method and an image forming apparatus using an electrophotographic photoconductor relating to the present invention as an image forming unit as described above.

The image forming unit may be fixed in and incorporated into copiers, facsimiles, and printers, or may be detachably incorporated into these devices in a form of a process cartridge. FIG. 2 exemplarily shows a process cartridge.

A process cartridge used for an image forming apparatus is a device or component that integrates a photoconductor 101 therein, and is provided with at least one selected from a charging unit 102, a developing unit 104, a transferring unit 106, a cleaning unit 107, and a charge eliminating unit (not shown), and is detachably mounted to a body of an image forming apparatus.

Herein, an image forming process using an apparatus exemplarily shown in FIG. 2 will be described. With the rotation of a photoconductor 101 in the direction indicated by the curved arrow, a latent electrostatic image corresponding to the exposed image is formed on the surface of the photoconductor 101 by charging the photoconductor surface by a charging unit 102 and exposing the photoconductor surface by an exposing unit 103, the latent electrostatic image is developed into a toner image by a developing unit 104, and the toner image is transferred onto a transferring member 105 by a transferring unit 106 to be printed out. Next, the surface of the photoconductor after transferring the image is cleaned by a cleaning unit 107 and further charge-removed by a charge eliminating unit (not shown). The above-mentioned operations are repeatedly performed.

According to the present invention, an electrophotographic photoconductor has a surface layer, the surface layer contains at least a trifunctional or more radical monomer having no electric charge transportable structure, a radical polymerizable monomer having an electric charge transportable structure, and a photo-radical polymerization initiator, and the surface layer is cured by a photo-energy irradiation unit. The present invention can provide an electrophotographic photoconductor capable of maintaining high abrasion resistance, excelling in surface smoothness, and having low-potential even at exposed regions over a long period of time by using a titanocene derivative for the photo-radical polymerization initiator, and making the absorption edge wavelength in the light absorption spectrum of the radical polymerizable monomer having an electric charge transportable structure 40 nm or more shorter than the absorption edge wavelength in the light absorption spectrum of the titanocene derivative. The present invention can also provide an image forming method and an image forming apparatus using the electrophotographic photoconductor.

Hereafter, the present invention will be further described in detail referring to specific examples, however, the present invention is not limited to the disclosed examples. It should be noted that “part” or “parts” represents “parts by mass”, and “%” represents “% by mass”.

### EXAMPLE 1

—Preparation of Photoconductor—

Over a surface of an aluminum cylinder having a diameter of 30 mm, an undercoat layer coating solution, a coating solution for an electric charge generating layer, and a coating solution for an electric charge transporting layer, respectively having the following composition, were applied sequentially, and the coated surface of the cylinder was dried to thereby form an undercoat layer having a thickness of 3.5 μm, an electric charge generating layer having a thickness of 0.2 μm, and an electric charge transporting layer having a thickness of 18 μm.

[Undercoat Layer Coating Solution]

| | |
|---|---|
| alkyd resin | 6 parts |
| (Beckozole 1307-60-EL, available from Dainippon Ink | |
| and Chemicals, Inc.) | |
| melamine resin | 4 parts |
| (Super-beckamine, available from Dainippon Ink and | |
| Chemicals, Inc.) | |
| titanium oxide | 40 parts |
| methylethylketone | 50 parts |

[Coating Solution for Electric Charge Generating Layer]

| | | |
|---|---|---|
| bis-azo pigment represented by the following Structural Formula (3) | 2.5 | parts |
| polyvinylbutyral (XYHL, available from Union Carbide Corp.) | 0.5 | parts |
| cyclohexanon | 200 | parts |
| methylethylketone | 80 | parts |

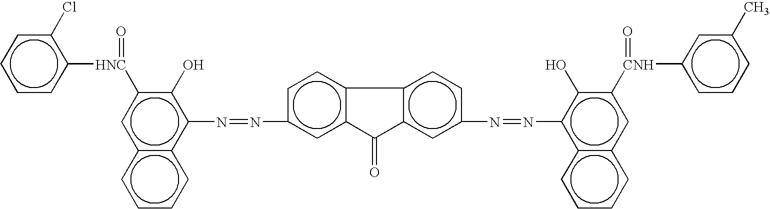

Structural Formula (3)

[Coating Solution for Electric Charge Transporting Layer]

| | | |
|---|---|---|
| bisphenol Z polycarbonate | 10 | parts |
| (Panlight TS-2050, available from Teijin Chemicals, Ltd.) | | |
| low-molecular electric charge transporting material | 7 | parts |
| represented by the following Structural Formula (4) | | |
| tetrahydrofuran | 100 | parts |
| tetrahydrofuran solution of 1% silicone oil | 1 | part |
| (KF50-100CS, available from Shin-Etsu | | |
| Chemical Co., Ltd.) | | |

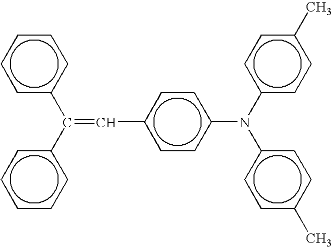

Structural Formula (4)

Next, a surface layer coating solution represented by the following composition was applied over a surface of a laminate structure provided with the conductive substrate, undercoat layer, electric charge generating layer, and electric charge transporting layer, and the surface of the laminate structure was irradiated with a UV lamp system (V bulb; available from Fusion Corp.) under the conditions of lamp output: 200 W/cm; luminous intensity: 450 mW/cm²; and irradiation time: 120 seconds, to make the surface layer crosslinked to thereby obtain a surface cured film of 5.2 μm in thickness. Thereafter, the surface layer was dried at 130° C. for 30 minutes to thereby obtain an electrophotographic photoconductor provided with the conductive substrate, the undercoat layer/the electric charge generating layer/the electric charge transporting layer, and the surface layer.

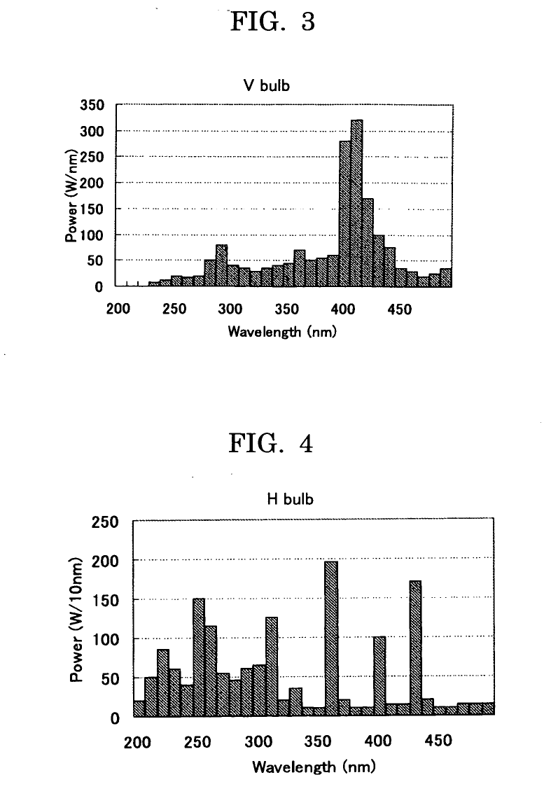

The light emission wavelength property of the V bulb used at that time had, as shown in FIG. 3, the maximum peak wavelength of 400 nm or more.

[Surface Layer Coating Solution]

| | |
|---|---|
| Trifunctional or more radical polymerizable monomer having | 10 parts |
| no electric charge transportable structure | |
| Trimethylolpropantriacrylate (KAYARAD TMPTA, available | |
| from Nippon Kayaku Co., Ltd.) | |
| Molecular mass: 296, Number of functional groups: | |
| trifunctional, Molecular mass/Number of functional groups = | |
| 99 | |
| Radical polymerizable compound having a monofunctional | 10 parts |
| electric charge transportable structure | |
| (Compound Example No. 4) | |
| Absorption edge wavelength 360 nm | |
| Photo-polymerization initiator | 1 part |
| bis(cyclopentadienyl)-bis(2,6-difuluoro-3-(pyrrole-1- | |
| yl)phenyl)titanium (IRGACURE 784, available from | |
| Chiba Specialty Chemicals K.K.) | |
| Absorption edge wavelength 549 nm | |
| Tetrahydrofuran | 100 parts |

### EXAMPLE 2

An electrophotographic photoconductor was prepared in the same manner as in Example 1 except that the radical polymerizable monomer having an electric charge transportable structure of Example 1 was changed to the one represented by the following structure.

| | |
|---|---|
| Radical polymerizable monomer having an electric charge | 10 parts |
| transportable structure | |
| (Triarylamine Compound Example No. 1) | |
| Absorption edge wavelength: 369 nm | |

### EXAMPLE 3

An electrophotographic photoconductor was prepared in the same manner as in Example 1 except that the radical polymerizable monomer having an electric charge transportable structure of Example 1 was changed to the one represented by the following structure.

| | |
|---|---|
| Radical polymerizable monomer having an electric charge | 10 parts |
| transportable structure | |
| (Triarylamine Compound Example No. 13) | |
| Absorption edge wavelength: 397 nm | |

### EXAMPLE 4

An electrophotographic photoconductor was prepared in the same manner as in Example 1 except that the radical polymerizable monomer having an electric charge transportable structure of Example 1 was changed to the one represented by the following structure.

| | |
|---|---|
| Radical polymerizable monomer having an electric charge | 10 parts |
| transportable structure | |
| (Triarylamine Compound Example No. 8) | |
| Absorption edge wavelength: 423 nm | |

### EXAMPLE 5

An electrophotographic photoconductor was prepared in the same manner as in Example 1 except that the radical polymerizable monomer having an electric charge transportable structure of Example 1 was changed to the one represented by the following structure.

| | |
|---|---|
| Radical polymerizable monomer having an electric charge | 10 parts |
| transportable structure | |
| (Triarylamine Compound Example No. 21) | |
| Absorption edge wavelength: 439 nm | |

### EXAMPLE 6

An electrophotographic photoconductor was prepared in the same manner as in Example 1 except that the radical polymerizable monomer having an electric charge transportable structure of Example 1 was changed to the one represented by the following structure.

| | |
|---|---|
| Radical polymerizable monomer having an electric charge | 10 parts |
| transportable structure | |
| (Triarylamine Compound Example No. 24) | |
| Absorption edge wavelength: 471 nm | |

### EXAMPLE 7

An electrophotographic photoconductor was prepared in the same manner as in Example 1 except that the radical polymerizable monomer having an electric charge transportable structure of Example 1 was changed to the one represented by the following structure.

| | |
|---|---|
| Radical polymerizable monomer having an electric charge | 10 parts |
| transportable structure | |
| (Triarylamine Compound Example No. 22) | |
| Absorption edge wavelength: 467 nm | |

### EXAMPLE 8

An electrophotographic photoconductor was prepared in the same manner as in Example 1 except that the trifunctional or more radical polymerizable monomer having no electric charge transportable structure contained in the crosslinked surface layer of Example 1 was changed to the following monomer.

| Trifunctional or more radical polymerizable monomer having | 10 parts |
|---|---|
| no electric charge transportable structure | |
| Dipentaerithritol hexaacrylate (KAYARAD DPHA, available | |
| from Nippon Kayaku Co., Ltd.) | |
| Average molecular mass: 536, Number of functional groups: | |
| 5.5 | |

### EXAMPLE 9

An electrophotographic photoconductor was prepared in the same manner as in Example 1 except that the radical polymerizable monomer having an electric charge transportable structure of Example 1 was changed to the one represented by the following structure, and as the light irradiation condition, the lamp system was changed to a lamp having the following light emission wavelength (H bulb, available from Fusion Corp.) to cure the surface layer.

| | |
|---|---|
| Radical polymerizable monomer having an electric charge | 10 parts |
| transportable structure | |
| (Triarylamine Compound Example No. 1) | |
| Absorption edge wavelength: 369 nm | |
| Bulb Light emission wavelength property is as shown in FIG. 4 | |

### EXAMPLE 10

An electrophotographic photoconductor was prepared in the same manner as in Example 1 except that the radical polymerizable monomer having an electric charge transportable structure of Example 1 was changed to the one represented by the following structure, and as the light irradiation condition, the lamp system was changed to a lamp having the following light emission wavelength (H bulb, available from Fusion Corp.) to cure the surface layer.

| | |
|---|---|
| Radical polymerizable monomer having an electric charge | 10 parts |
| transportable structure | |
| (Triarylamine Compound Example No. 8) | |
| Absorption edge wavelength: 423 nm | |
| Bulb light emission wavelength property is as shown in FIG. 4 | |

### COMPARATIVE EXAMPLE 1

An electrophotographic photoconductor was prepared in the same manner as in Example 2 except that the photo-polymerization initiator of Example 2 was changed to a compound represented by the following structural formula (5).

| | |
|---|---|
| Photo-polymerization initiator | 0.6 parts |
| 4,4′-bis(dimethylamino)benzophenone | |
| (Michler's ketone, available from TOKYO CHEMICAL | |
| INDUSTRY CO., LTD.) | |
| Absorption edge wavelength 398 nm | |

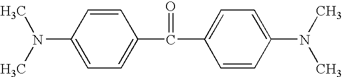

Structural Formula (5)

### COMPARATIVE EXAMPLE 2

An electrophotographic photoconductor was prepared in the same manner as in Example 3 except that the photo-polymerization initiator of Example 3 was changed to a compound represented by the above stated structural formula (5).

| | |
|---|---|
| Photo-polymerization initiator | 0.6 parts |
| 4,4′-bis(dimethylamino)benzophenone | |
| (Michler′s ketone, available from TOKYO CHEMICAL | |
| INDUSTRY CO., LTD.) | |

### COMPARATIVE EXAMPLE 3

An electrophotographic photoconductor was prepared in the same manner as in Example 4 except that the photo-polymerization initiator of Example 4 was changed to a compound represented by the above stated structural formula (5).

| | |
|---|---|
| Photo-polymerization initiator | 0.6 parts |
| 4,4′-bis(dimethylamino)benzophenone | |
| (Michler′s ketone, available from TOKYO CHEMICAL | |
| INDUSTRY CO., LTD.) | |

### COMPARATIVE EXAMPLE 4

An electrophotographic photoconductor was prepared in the same manner as in Example 2 except that the photo-polymerization initiator of Example 2 was changed to a compound represented by the following structural formula (6).

| | |
|---|---|
| Photo-polymerization initiator | 0.6 parts |
| Carbazole-phenon initiator | |
| (Adecaoptomer N-1414, available from | |
| Asahi Denka Co., Ltd.) | |
| Absorption edge wavelength: 370 nm | |

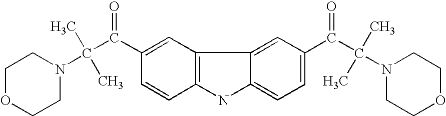

Structural Formula (6)

### COMPARATIVE EXAMPLE 5

An electrophotographic photoconductor was prepared in the same manner as in Example 3 except that the photo-polymerization initiator of Example 3 was changed to a compound represented by the above stated structural formula (6).

| | |
|---|---|
| Photo-polymerization initiator | 0.6 parts |
| Carbazole-phenon initiator | |
| (Adecaoptomer N-1414, available from Asahi | |
| Denka Co., Ltd.) | |

### COMPARATIVE EXAMPLE 6

An electrophotographic photoconductor was prepared in the same manner as in Example 4 except that the photo-polymerization initiator of Example 4 was changed to a compound represented by the above stated structural formula (6).

| | |
|---|---|
| Photo-polymerization initiator | 0.6 parts |
| Carbazole-phenon initiator | |
| (Adecaoptomer N-1414, available from | |
| Asahi Denka Co., Ltd.) | |

### COMPARATIVE EXAMPLE 7

An electrophotographic photoconductor was prepared in the same manner as in Example 1 except that the radical polymerizable monomer having an electric charge transporting structure of Example 1 was changed to the one represented by the following structural formula.

| | |
|---|---|
| Radical polymerizable monomer having an electric charge | 10 parts |
| transportable structure | |
| (Triarylamine Compound Example No. 33) | |
| Absorption edge wavelength: 527 nm | |

### COMPARATIVE EXAMPLE 8

An electrophotographic photoconductor was prepared in the same manner as in Comparative Example 7 except that the photo-polymerization initiator of Comparative Example 7 was changed to a compound represented by the above stated structural formula (5).

| | |
|---|---|
| Photo-polymerization initiator | 0.6 parts |
| 4,4′-bis(dimethylamino)benzophenone | |
| (Michler′s ketone, available from TOKYO CHEMICAL | |
| INDUSTRY CO., LTD.) | |

### COMPARATIVE EXAMPLE 9

An electrophotographic photoconductor was prepared in the same manner as in Comparative Example 7 except that the photo-polymerization initiator of Comparative Example 7 was changed to a compound represented by the above stated structural formula (6).

| | |
|---|---|
| Photo-polymerization initiator | 0.6 parts |
| Carbazole-phenon initiator | |
| (Adecaoptomer N-1414, available from | |
| Asahi Denka Co., Ltd.) | |

### COMPARATIVE EXAMPLE 10

An electrophotographic photoconductor was prepared in the same manner as in Example 10 except that the photo-polymerization initiator of Example 10 was changed to a compound represented by the above stated structural formula (6).

| | |
|---|---|
| Photo-polymerization initiator | 0.6 parts |
| Carbazole-phenon initiator | |
| (Adecaoptomer N-1414, available | |
| from Asahi Denka Co., Ltd.) | |

### COMPARATIVE EXAMPLE 11

An electrophotographic photoconductor was prepared in the same manner as in Example 1 except that the trifunctional or more radical polymerizable monomer having no electric charge transportable structure contained in the coating solution for the crosslinked surface layer of Example 1 was changed to 10 parts of the following bifunctional radical polymerizable monomer having no electric charge transportable structure.

| | |
|---|---|
| Bifunctional radical polymerizable monomer having no | 10 parts |
| electric charge transportable structure | |
| 1,6-hexanedioldiacrylate | |
| Molecular mass: 226, Number of functional groups: | |
| bifunctional | |
| (available from Wako Pure Chemical Industries, Ltd.) | |

### COMPARATIVE EXAMPLE 12

An electrophotographic photoconductor was prepared in the same manner as in Example 1 except that the trifunctional or more radical polymerizable monomer having no electric charge transportable structure of the composition used for the coating solution for the crosslinked surface layer of Example 1 was not contained in the coating solution for Comparative Example 12, and the content of the radical polymerizable monomer having an electric charge transportable structure was changed to 20 parts.

### COMPARATIVE EXAMPLE 13

An electrophotographic photoconductor was prepared in the same manner as in Example 1 except that the radical polymerizable compound having an electric charge transportable structure of the composition used for the coating solution for the crosslinked surface layer of Example 1 was not contained in the coating solution for Comparative Example 13, and the content of the trifunctional or more radical polymerizable monomer having no electric charge transportable structure was changed to 20 parts.

### COMPARATIVE EXAMPLE 14

An electrophotographic photoconductor was prepared in the same manner as in Example 1 except that the radical polymerizable compound having an electric charge transportable structure of the composition used for the coating solution for the crosslinked surface layer of Example 1 was not contained, instead thereof, 10 parts of a low-molecular electric charge transporting material represented by the Structural Formula (4) used for the coating solution for electric charge transporting layer was contained in the coating solution for the crosslinked surface layer of Comparative Example 14.

TABLE 4

| | | | Absorption edge | | | |
|---|---|---|---|---|---|---|
| | | | wavelength | | Maximum | |
| | | | | Electric | light | |
| | | Electric | | charge | emission | |
| | | charge | | transporting | wavelength | |
| | | transporting | Initiator | material | of used light | |
| | Initiator | material | HA | HB | source | HA − HB |
| Ex. 1 | titanocene | No. 4 | 549 nm | 360 nm | 410 nm | 189 nm |
| Ex. 2 | titanocene | No. 1 | 549 nm | 369 nm | 410 nm | 180 nm |
| Ex. 3 | titanocene | No. 13 | 549 nm | 397 nm | 410 nm | 152 nm |
| Ex. 4 | titanocene | No. 8 | 549 nm | 423 nm | 410 nm | 126 nm |
| Ex. 5 | titanocene | No. 21 | 549 nm | 439 nm | 410 nm | 110 nm |
| Ex. 6 | titanocene | No. 24 | 549 nm | 471 nm | 410 nm | 78 nm |
| Ex. 7 | titanocene | No. 22 | 549 nm | 467 nm | 410 nm | 82 nm |
| Ex. 8 | titanocene | No. 4 | 549 nm | 360 nm | 410 nm | 189 nm |
| Ex. 9 | titanocene | No. 1 | 549 nm | 369 nm | 360 nm | 180 nm |
| Ex. 10 | titanocene | No. 8 | 549 nm | 423 nm | 360 nm | 126 nm |
| Compara. | Michler's | No. 1 | 398 nm | 369 nm | 410 nm | 29 nm |
| Ex. 1 | ketone | | | | | |
| Compara. | Michler's | No. 13 | 398 nm | 397 nm | 410 nm | 1 nm |
| Ex. 2 | ketone | | | | | |
| Compara. | Michler's | No. 8 | 398 nm | 423 nm | 410 nm | −25 nm |
| Ex. 3 | ketone | | | | | |
| Compara. | carbazole- | No. 1 | 370 nm | 369 nm | 410 nm | 1 nm |
| Ex. 4 | phenon | | | | | |
| Compara. | carbazole- | No. 13 | 370 nm | 397 nm | 410 nm | −27 nm |
| Ex. 5 | phenon | | | | | |
| Compara. | carbazole- | No. 8 | 370 nm | 423 nm | 410 nm | −53 nm |
| Ex. 6 | phenon | | | | | |
| Compara. | titanocene | No. 33 | 549 nm | 527 nm | 410 nm | 22 nm |
| Ex. 7 | | | | | | |
| Compara. | Michler's | No. 33 | 393 nm | 527 nm | 410 nm | −134 nm |
| Ex. 8 | ketone | | | | | |
| Compara. | carbazole- | No. 33 | 361 nm | 527 nm | 410 nm | −166 nm |
| Ex. 9 | phenon | | | | | |
| Compara. | Michier's | No. 8 | 393 nm | 423 nm | 360 nm | −30 nm |
| Ex. 10 | ketone | | | | | |
| Compara. | titanocene | No. 4 | 549 nm | 360 nm | 410 nm | 189 nm |
| Ex. 11 | | | | | | |
| Compara. | titanocene | No. 4 | 549 nm | 360 nm | 410 nm | 189 nm |
| Ex. 12 | | | | | | |
| Compara. | titanocene | No. 4 | 549 nm | 360 nm | 410 nm | 189 nm |
| Ex. 13 | | | | | | |
| Compara. | titanocene | No. 4 | 549 nm | 360 nm | 410 nm | 189 nm |
| Ex. 14 | | | | | | |

<Surface Smoothness Test>

As an evaluation method of surface smoothness of the obtained photoconductors, the respective photoconductor surfaces were evaluated as to surface roughness Rz (10 points of average roughness based on JIS B0601-1994 standards) relative to the evaluation length of 2.5 mm and the standard length of 0.5 mm, using SURFCOM 1400D (available from TOKYOSEIMITSU CO., LTD.). For the evaluation sites of the test sample photoconductor, 2 points of 50 mm from both ends of the drum in the axial direction of the drum and one point of the central part of the drum were measured 4-fold in the circumferential direction at an angle of 90 degrees, i.e. 12 points were measured in total. Then, the average value was defined as the surface roughness Rz of the drum.

<Curability Test>

As an indicator of curing progress of the crosslinked surface layer, a test of solubility to the used organic solvent was performed. A drop of tetrahydrofuran (THF) was dropped on the surface of the test sample photoconductor, the surface was dried naturally, and then the change in surface geometry thereof was visually checked. The drum surface that the curing had not progressed had a partially dissolved surface, and had ring-shaped irregularities and tarnish on the surface layer.

<Durability Test>

The crosslinked surface layer of 10 cm in width in the axial direction of the test sample photoconductor was made worn around 1.5 μm at an arbitrarily selected portion of the photoconductor using a wrapping film having a surface roughness of 0.3 μm (available from Sumitomo 3M Ltd.). In Imagio MF 2200 remodeled system (available from Ricoh Company Ltd.) utilizing a semiconductor laser having a wavelength of 655 nm as the light source of image exposure, in which the photoconductor was attached to a process cartridge for electrophotographic system, the initial umbra potential was set to −700V at a region of the crosslinked surface layer that had not been worn using the wrapping film. Then, 50,000 sheets of A4-size paper in total were passed through the remodeled system to measure, at the early stage of the paper-passing test and with respect to each 20,000 sheets of paper, the thickness of the crosslinked surface layer that had been worn using the wrapping film and evaluate the image. As electric properties of the photoconductor when the paper-passing test was completed, the umbra potential and the potential of exposed region were measured at the same position as the measured portion of the initial umbra potential. The thickness of the photoconductor was measured using an eddy-current thickness measuring device (available from Fisher Instrument Company).

Table 5 shows evaluation results of electrophotographic photoconductors of Examples 1 to 10 and Comparative Examples 1 to 14 with respect to the initial surface roughness Rz and the solubility to THF.

TABLE 5

| | Initial | |
|---|---|---|
| | surface | |
| | roughness | Curing |
| | Rz (μm) | test |
| Ex. 1 | 0.20 | insoluble |
| Ex. 2 | 0.22 | insoluble |
| Ex. 3 | 0.23 | insoluble |
| Ex. 4 | 0.21 | insoluble |
| Ex. 5 | 0.24 | insoluble |
| Ex. 6 | 0.24 | insoluble |
| Ex. 7 | 0.23 | insoluble |
| Ex. 8 | 0.26 | insoluble |
| Ex. 9 | 0.30 | insoluble |
| Ex. 10 | 0.29 | insoluble |
| Compara. | 0.21 | insoluble |
| Ex. 1 | | |
| Compara. | 0.22 | insoluble |
| Ex. 2 | | |
| Compara. | 0.20 | soluble |
| Ex. 3 | | |
| Compara. | 0.24 | insoluble |
| Ex. 4 | | |
| Compara. | 0.22 | soluble |
| Ex. 5 | | |
| Compara. | 0.27 | soluble |
| Ex. 6 | | |
| Compara. | 0.20 | insoluble |
| Ex. 7 | | |
| Compara. | 0.25 | soluble |
| Ex. 8 | | |
| Compara. | 0.23 | soluble |
| Ex. 9 | | |
| Compara. | 0.21 | soluble |
| Ex. 10 | | |
| Compara. | 0.51 | soluble |
| Ex. 11 | | |
| Compara. | Impossible to cure | |
| Ex. 12 | | |
| Compara. | 1.35 | insoluble |
| Ex. 13 | | |
| Compara. | 0.23 | soluble |
| Ex. 14 | | |

The evaluation results shown in Table 5 demonstrated that the electrophotographic photoconductors of the present invention produced in Examples 1 to 10 respectively had excellent surface smoothness. In addition, any of surface layers of these photoconductors were insoluble to the organic solvent, and this shows that the surfaces of the photoconductors had been sufficiently cured. In contrast, the electrophotographic photoconductor of Comparative Example 11 using the bifunctional monomer for the crosslinked surface layer, and the electrophotographic photoconductor of Comparative Example 13 using only the trifunctional or more radical polymerizable monomer for the crosslinked surface layer respectively showed very poor surface smoothness. For the electrophotographic photoconductors of Comparative Examples 3, 5, 6, 8, and 9, the absorption edge wavelength of the radical polymerizable monomer having an electric charge transportable structure was positioned at longer wavelength side than that of the used photo-radical polymerization initiator, and it seemed that the surface layers were insufficiently crosslinked because of difficulty in making radical efficiently generate. For the electrophotographic photoconductor of Comparative Example 10, the maximum emission wavelength of the used light source was shorter than that of the used electric charge transporting material, and thus it is conceivable that it had a curing failure resulting from insufficient radical generation.

Next, a durability test was performed as to the electrophotographic photoconductors of Examples 1 to 10 and Comparative Examples 1 to 11 and 13 to 14. Table 6A and 6B show the evaluation results.

TABLE 6A

| | | | | | | Surface potential | |
|---|---|---|---|---|---|---|---|
| | | | | Initial surface | | upon completion of | |
| | Abrasion wear (μm) | | | potential (−V) | | paper-passing (−V) | |
| | | 30,000 | 50,000 | | Exposed | | Exposed |
| | 10,000 sheets | sheets | sheets | Umbra | region | Umbra | region |
| Ex. 1 | 0.19 | 0.39 | 0.63 | 700 | 75 | 680 | 80 |
| Ex. 2 | 0.22 | 0.42 | 0.61 | 700 | 70 | 675 | 75 |
| Ex. 3 | 0.23 | 0.47 | 0.70 | 700 | 60 | 675 | 65 |
| Ex. 4 | 0.20 | 0.44 | 0.62 | 700 | 65 | 690 | 70 |
| Ex. 5 | 0.21 | 0.38 | 0.65 | 700 | 70 | 680 | 70 |
| Ex. 6 | 0.15 | 0.35 | 0.59 | 700 | 65 | 680 | 65 |
| Ex. 7 | 0.22 | 0.41 | 0.61 | 700 | 65 | 690 | 65 |
| Ex. 8 | 0.25 | 0.44 | 0.72 | 700 | 80 | 680 | 85 |
| Ex. 9 | 0.23 | 0.40 | 0.69 | 700 | 80 | 675 | 90 |
| Ex. 10 | 0.19 | 0.46 | 0.66 | 700 | 75 | 690 | 85 |

TABLE 6B

| | | | | Initial surface | | Surface potential | |
|---|---|---|---|---|---|---|---|
| | Abrasion wear (μm) | | | potential (−V) | | upon completion of | |
| | 10,000 | 30,000 | 50,000 | | Exposed | paper-passing (−V) | |
| | sheets | sheets | sheets | Umbra | region | Umbra | Exposed region |
| Compara. | Image density was lowered | | | 700 | 250 | — | — |
| Ex. 1 | at the early stage, and | | | | | | |
| | the running test | | | | | | |
| | of paper-passing | | | | | | |
| | was ceased. | | | | | | |
| Compara. | Image density was | | | 700 | 265 | — | — |
| Ex. 2 | lowered at the | | | | | | |
| | early stage, and the | | | | | | |
| | running test | | | | | | |
| | of paper-passing | | | | | | |
| | was ceased. | | | | | | |
| Compara. | Image density was | | | 700 | 260 | — | — |
| Ex. 3 | lowered at the early | | | | | | |
| | stage, and the running test | | | | | | |
| | of paper-passing | | | | | | |
| | was ceased. | | | | | | |
| Compara. | 0.42 | 1.23 | 3.12 | 700 | 100 | 670 | 185 |
| Ex. 4 | | | | | | | |
| Compara. | 0.55 | 1.92 | 5.18 | 700 | 120 | 690 | 170 |
| Ex. 5 | | | | | | | |
| Compara. | 0.80 | 3.12 | 8.01 | 700 | 95 | 690 | 155 |
| Ex. 6 | | | | | | | |
| Compara. | 0.29 | 0.56 | 1.99 | 700 | 75 | 670 | 125 |
| Ex. 7 | | | | | | | |
| Compara. | Image density | | | 700 | 280 | — | — |
| Ex. 8 | was lowered at the | | | | | | |
| | early stage, and | | | | | | |
| | the running test | | | | | | |
| | of paper-passing | | | | | | |
| | was ceased. | | | | | | |
| Compara. | 1.02 | 4.11 | 9.21 | 700 | 85 | 670 | 75 |
| Ex. 9 | | | | | | | |
| Compara. | Image density | | | 700 | 310 | — | — |
| Ex. 10 | was lowered at the | | | | | | |
| | early stage, and | | | | | | |
| | the running test | | | | | | |
| | of paper-passing | | | | | | |
| | was ceased. | | | | | | |
| Compara. | 0.81 | 1.65 | 2.64 | 700 | 70 | 680 | 110 |
| Ex. 11 | | | | | | | |
| Compara. | Image density was | | | 700 | 250 | — | — |
| Ex. 13 | lowered at the | | | | | | |
| | early stage, and the | | | | | | |
| | running test | | | | | | |
| | of paper-passing | | | | | | |
| | was ceased. | | | | | | |
| Compara. | 1.29 | 2.62 | 4.88 | 700 | 85 | 660 | 75 |
| Ex. 14 | | | | | | | |

The results shown in Tables 6A and 6B demonstrated that the electrophotographic photoconductors of the present invention produced in Examples 1 to 10 respectively had a low potential in exposed regions and showed excellent electric property at the early stage of the test and before and after the durability test of 50,000 sheets of paper. In contrast, for the electrophotographic photoconductors using a photo-polymerization initiator having a long wavelength other than titanocene derivatives, shown in Comparative Examples 1 to 3, 8, and 10, and the electrophotographic photoconductor using a crosslinked surface layer containing only a radical polymerizable monomer having no electric charge transportable group, electric properties thereof were profoundly degraded.

The electrophotographic photoconductors of Examples 1 to 10 had less thickness reduction in the durability test of 50,000 sheets of paper and achieved high-durability.

In contrast, for the electrophotographic photoconductors of Comparative Examples 4 to 6 each using a photo-radical polymerizable initiator other than titanocene derivatives for the surface layer, the electrophotographic photoconductors of Comparative Examples 7 and 9 each of which the absorption edge wavelength of the electric charge transporting material used for the surface layer was longer than that of the used photo-radical polymerization initiator, the electrophotographic photoconductor of Comparative Example 11 using a bifunctional radical polymerizable monomer having no electric charge transportable structure, and the electrophotographic photoconductor of Comparative Example 14 containing a low-molecular electric charge transporting material in the surface layer, any of these photoconductors had a large amount of abrasion wear of the surface layer at the time when the running of paper-passing was completed. For the electrophotographic photoconductors of Comparative Examples 4 to 6, 7, and 9, increase in abrasion wear was observed in the middle of the running test of paper-passing, and this implies that each of the surface layers were not uniformly cured through to the inside thereof.

<Image Density>

The image densities at the time when 10,000 sheets of paper, 30,000 sheets of paper, and 50,000 sheets of paper were passed through the evaluation system using the respective electrophotographic photoconductors were observed and evaluated based on the following criteria. Table 7 shows evaluation results.

[Evaluation Criteria]

A: Excellent in image density

B: Image density was slightly lowered

C: Image density was lowered

TABLE 7

Image density

| | | 10,000 | 30,000 | 50,000 |
|---|---|---|---|---|
| | Early stage | sheets | sheets | sheets |
| Ex. 1 | A | A | A | A |
| Ex. 2 | A | A | A | A |
| Ex. 3 | A | A | A | A |
| Ex. 4 | A | A | A | A |
| Ex. 5 | A | A | A | A |
| Ex. 6 | A | A | A | A |
| Ex. 7 | A | A | A | A |
| Ex. 8 | A | A | A | A |
| Ex. 9 | A | A | A | A |
| Ex. 10 | A | A | A | A |
| Compara. | A | A | B | C |
| Ex. 4 | | | | |
| Compara. | A | A | B | C |
| Ex. 5 | | | | |
| Compara. | A | A | C | C |
| Ex. 6 | | | | |
| Compara. | A | B | C | C |
| Ex. 7 | | | | |
| Compara. | A | B | C | C |
| Ex. 9 | | | | |
| Compara. | A | B | C | C |
| Ex. 11 | | | | |
| Compara. | A | B | C | C |
| Ex. 14 | | | | |

The results shown in Table 7 demonstrated that it was possible to obtain an excellent image having no reduction in image density using electrophotographic photoconductors produced in Examples of the present invention, respectively. In contrast, with the individual electrophotographic photoconductors of Comparative Examples, reduction of image density was observed.

Accordingly, these tests found that an electrophotographic photoconductor, in which a trifunctional or more radial polymerizable monomer having no electric charge transportable structure, a radical polymerizable monomer having an electric charge transportable structure, and a titanocene derivative as a photo-radical polymerization initiator, described in the present invention, are used, and the absorption edge wavelength in the light absorption spectrum of the radical polymerizable monomer having an electric charge transportable structure is 40 nm or more shorter than that of the titanocene derivative, excels in surface smoothness, has a low-potential at exposed regions, high-durability, and longer operating life. In addition, it was also found that an image forming process, an image forming apparatus, and a process cartridge for the image forming apparatus using the electrophotographic photoconductor of the present invention allow obtaining high-performance and high-reliability.

What is claimed is:

1. An electrophotographic photoconductor comprising:
a substrate,
at least a photosensitive layer and a surface layer being formed on the substrate in this order,
wherein the surface layer comprises a cured material which is cured by irradiating with light a trifunctional or more radical polymerizable monomer having no electric charge transportable structure, a radical polymerizable monomer having an electric charge transportable structure, and a photo-radical polymerization initiator; the photo-radical polymerization initiator comprises a titanocene derivative; and the relation between the absorption edge wavelength HA (nm) in the light absorption spectrum of the radical polymerization initiator and the absorption edge wavelength HB (nm) in the light absorption spectrum of the radical polymerizable monomer having an electric charge transportable structure is represented by HA>HB and satisfies HA−HB>40 nm.

2. The electrophotographic photoconductor according to claim 1, wherein the absorption edge wavelength in the light absorption spectrum of the radical polymerizable monomer having an electric charge transportable structure is 370 nm or more.

3. The electrophotographic photoconductor according to claim 1, wherein the absorption edge wavelength in the light absorption spectrum of the radical polymerizable monomer having an electric charge transportable structure is 400 nm or more.

4. The electrophotographic photoconductor according to claim 1, wherein the number of polymerizable groups of the radical polymerizable monomer having an electric charge transportable structure is one.

5. The electrophotographic photoconductor according to claim 1, wherein a light source having the maximum emission peak wavelength at a wavelength range of 400 nm or more is used in the light irradiation.

6. The electrophotographic photoconductor according to claim 1, wherein the functional group of the radical polymerizable monomer having an electric charge transportable structure is at least any one of an acryloyloxy group and a methacryloyloxy group.

7. The electrophotographic photoconductor according to claim 1, wherein the functional group of the trifunctional or more radical polymerizable monomer having no electric charge transportable structure is at least any one of an acryloyloxy group and a methacryloyloxy group.

8. The electrophotographic photoconductor according to claim 1, wherein the ratio of the molecular mass of the trifunctional or more radical polymerizable monomer having no electric charge transportable structure relative to the number of functional groups thereof (molecular mass/number of functional groups) is 250 or less.

9. The electrophotographic photoconductor according to claim 1, wherein each of the electric charge transportable sites of the radical polymerizable monomer has a triarylamine structure.

10. The electrophotographic photoconductor according to claim 1, wherein the radical polymerizable monomer having an electric charge transportable structure is represented by any one of the following General Formulas (1) and (2). 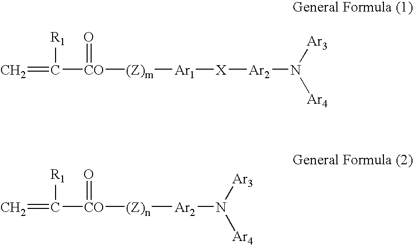
wherein R₁ represents a hydrogen atom, a halogen atom, an alkyl group that is allowed to have a substituted group, an aralkyl group that is allowed to have a substituted group, an aryl group, a cyano group, a nitro group or an alkoxy group that is allowed to have a substituted group, or —COOR₇ (R₇ represents a hydrogen atom, an alkyl group that is allowed to have a substituted group, an aralkyl group that is allowed to have a substituted group, or an aryl group that is allowed to have a substituted group); a halogenated carbonyl group or CONR₈R₉ (R₈ and R₉ respectively represents a hydrogen atom, a halogen atom, an alkyl group that is allowed to have a substituted group, an aralkyl group that is allowed to have a substituted group, or an aryl group that is allowed to have a substituted group); Ar₁ and Ar₂ respectively represent a substituted or unsubstituted arylene group and may be the same or different from each other; Ar₃ and Ar₄ respectively represent a substituted or unsubstituted aryl group and may be the same or different from each other; X represents a single bond, a substituted or unsubstituted alkylene group, a substituted or unsubstituted cycloalkylene group, a substituted or unsubstituted alkylene ether divalent group, an oxygen atom, a sulfur atom, or a vinylene group; Z represents a substituted or unsubstituted alkylene group, a substituted or unsubstituted alkylene ether divalent group or an alkyleneoxycarbonyl divalent group; and “m” and “n” respectively represent an integer of 0 to 3.

11. The electrophotographic photoconductor according to claim 1, wherein the radical polymerizable monomer having an electric charge transportable structure is at least one selected from compounds represented by the following General Formula (3): 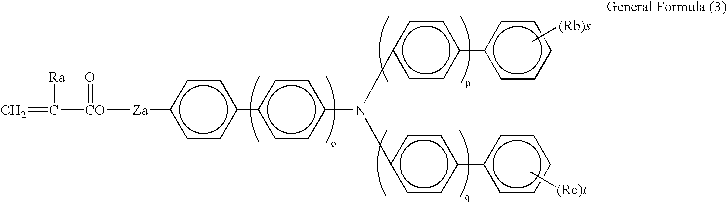
wherein “o”, “p”, “q” respectively represent an integer of 0 or 1; Ra represents a hydrogen atom, or a methyl group; Rb and Rc respectively represent an alkyl group having 1 to 6 carbon atoms, and when they respectively have a plurality of alkyl groups, the alkyl groups may be different from each other; “s” and “t” respectively represent an integer of 0 to 3; and Za represents a single bond, a methylene group, an ethylene group or any one of compounds represented by one of the following formulas:

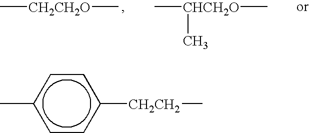

12. The electrophotographic photoconductor according to claim 1, wherein the radical polymerizable monomer having an electric charge transportable structure is at least one selected from acrylic acid ester compounds represented by the following General Formula (4):
B₁—Ar₁—CH═CH—Ar₂—B₂
wherein Ar₁ represents a monovalent group or a divalent group which comprises a substituted or unsubstituted aromatic hydrocarbon skeleton; Ar₂ represents a monovalent group or a divalent group which comprises an aromatic hydrocarbon skeleton having at least one tertiary amino group, or a monovalent group or a divalent group which contains a heterocyclic compound having at least one tertiary amino group; and either B₁ or B₂ exists or both B₁ and B₂ exist in the compound and respectively represent an acryloyloxy group, a methacryloyloxy group, a vinyl group, an alkyl group having an acryloyloxy group, a methacryloyloxy group or a vinyl group, or an alkoxy group having an acryloyloxy group, a methacryloyloxy group or a vinyl group.

13. The electrophotographic photoconductor according to claim 1, wherein the radical polymerizable monomer having an electric charge transportable structure is at least one selected from compounds represented by the following General Formula (5): 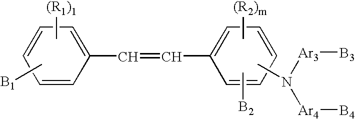
wherein R₁ and R₂ respectively represent a substituted or unsubstituted alkyl group, a substituted or unsubstituted alkoxy group, or a halogen atom; Ar₃ and Ar₄ respectively represent a substituted or unsubstituted aryl group or arylene group, or a substituted or unsubstituted benzyl group; B₁, B₂, B₃, and B₄ are the same as defined for B₁ and B₂, only one of the B₁, B₂, B₃, and B₄ exists or only two of them exist in the compound and the presence of three or more is excluded; “l” is an integer of 0 to 5; and “m” is an integer of 0 to 4.

14. The electrophotographic photoconductor according to claim 1, wherein the titanocene derivative is bis(cyclopentadienyl)-bis(2,6-difluoro-3-(pyrrole-1-yl)phenyl)titanium.

15. The electrophotographic photoconductor according to claim 1, wherein the photosensitive layer has an electric charge generating layer, an electric charge transporting layer, and the surface layer in this order on the substrate.

16. An image forming method comprising:
forming a latent electrostatic image on an electrophotographic photoconductor,
developing the latent electrostatic image using a toner to form a visible image,
transferring the visible image onto a recording medium, and
fixing the transferred image on the recording medium,
wherein the electrophotographic photoconductor comprises a substrate, at least a photosensitive layer and a surface layer being formed on the substrate in this order; the surface layer comprises a cured material which is cured by irradiating with light a trifunctional or more radical polymerizable monomer having no electric charge transportable structure, a radical polymerizable monomer having an electric charge transportable structure, and a photo-radical polymerization initiator; the photo-radical polymerization initiator comprises a titanocene derivative; and the relation between the absorption edge wavelength HA (nm) in the light absorption spectrum of the radical polymerization initiator and the absorption edge wavelength HB (nm) in the light absorption spectrum of the radical polymerizable monomer having an electric charge transportable structure is represented by HA>HB and satisfies HA−HB>40 nm.

17. A process cartridge that can be detachably incorporated into a body of an image forming apparatus comprising:
an electrophotographic photoconductor, and
at least one selected from:
a charging unit configured to charge the surface of the electrophotographic photoconductor,
a developing unit configured to develop a latent electrostatic image formed on the electrophotographic photoconductor using a toner to form a visible image,
a transferring unit configured to transfer the visible image onto a recording medium, and
a cleaning unit configured to remove a residual toner on the electrophotographic photoconductor,
wherein the electrophotographic photoconductor comprises a substrate, at least a photosensitive layer and a surface layer being formed on the substrate in this order; the surface layer comprises a cured material which is cured by irradiating with light a trifunctional or more radical polymerizable monomer having no electric charge transportable structure, a radical polymerizable monomer having an electric charge transportable structure, and a photo-radical polymerization initiator; the photo-radical polymerization initiator comprises a titanocene derivative; and the relation between the absorption edge wavelength HA (nm) in the light absorption spectrum of the radical polymerization initiator and the absorption edge wavelength HB (nm) in the light absorption spectrum of the radical polymerizable monomer having an electric charge transportable structure is represented by HA>HB and satisfies HA−HB>40 nm.
